(19) United States
(12) Patent Application Publication
(10) Pub. No.: US 2026/0204245 A1
(43) Pub. Date: Jul. 16, 2026

(54) KARAOKE SOUND SYSTEM WITH INTELLIGENT WIRELESS MICROPHONES

(71) Applicant: Vizio, Inc., Irvine, CA (US)

(72) Inventors: Glen Gihong Kim, Anaheim, CA (US); Kasin Chan, Chino, CA (US)

(21) Appl. No.: 19/402,650

(22) Filed: Nov. 26, 2025

Related U.S. Application Data
(60) Provisional application No. 63/725,978, filed on Nov. 27, 2024.

(51) Int. Cl. G10H 1/36

(52) U.S. Cl. CPC G10H 1/366; G10H 2220/066; G10H 2220/201; G10H 2220/211; G10H 2240/211; G10H 2240/251

(57) ABSTRACT

Example karaoke microphones are shown and described. The microphones may include inertial sensors to activate or modulate a vocal effect applied to the audio signal transmitted from the microphone to an amplifier. The microphones may include translucent housings and internal light sources to indicate a state of the microphone. In certain examples, the microphone can be converted to a gaming controller by replacing the capsule that contains an acoustic-electric transducer with a gaming attachment. The gaming attachment may include a translucent housing and at least one light source in the housing. The control unit in the microphone housing causes the light source in the attachment to activate based on an inertial sensor signal from the inertial sensor. Gaming controllers with inertial sensors and internal light sources used to emulate musical instruments are also shown and described.

### CROSS REFERENCE TO RELATED APPLICATIONS

This application claims the benefit of U.S. Provisional Patent Application 63/725,978, filed November 27, 2024, the entirety of which is hereby incorporated by reference.

### FIELD

This disclosure relates to audio equipment, specifically to a karaoke soundbar and microphone system with advanced features for karaoke singers. The system allows users to control audio effects and lighting through intuitive gestures and a smartphone application.

### BACKGROUND

Karaoke is an interactive entertainment system, usually offered in clubs, bars, and restaurants, in which people sing along to pre-recorded versions of popular songs. Karaoke systems may include one or more microphones and a speaker system. Traditional karaoke systems provide limited interaction and control for the user. The use of wireless microphones and soundbar systems in karaoke singing entertainment has seen a significant rise in popularity over recent years. Karaoke, originating from Japan, has become a global phenomenon, providing a platform for individuals to engage in recreational singing. Traditional karaoke setups often involved complex, wired systems, which could be cumbersome and limited the mobility of users. The advent of wireless technology revolutionized the karaoke experience, making it more user- friendly and accessible. However, despite these advancements, there remain several challenges and limitations that affect the overall performance and user experience of wireless karaoke systems.

Another concern is the sound quality of wireless microphones and soundbars. High-fidelity audio is crucial for an enjoyable karaoke session, as it ensures that both the singer and the audience can appreciate the performance. Many existing systems do not provide as convenient way to enhance vocals using vocal effects such as chorus, echo, delay, flange, reverb, and pitch.

In light of these challenges, this karaoke systems described herein aim to address the existing shortcomings of wireless microphone and soundbar systems used in karaoke singing entertainment. By leveraging advanced wireless technology, improved audio processing capabilities, and user-centric design principles, this disclosure seeks to enhance the overall karaoke experience, providing users with a seamless, high-quality, and enjoyable singing environment.

### SUMMARY

In accordance with a first aspect of the present disclosure, a microphone is provided which comprises an inertial sensor, a control a unit operatively connected to the inertial sensor; and a transmitter, wherein the control unit is operatively connected to the transmitter to transmit a control signal.

In accordance with a second aspect of the present disclosure, a karaoke system is provided which comprises a karaoke system that includes a microphone, and a soundbar comprising at least one speaker, at least one wireless signal receiver, a processor, and a vocal effects module, wherein in response to a control signal received from the microphone, the vocal effects module applies a vocal effect to an audio signal received from the microphone. The microphone comprises an inertial sensor, a control a unit operatively connected to the inertial sensor, and a transmitter.

In accordance with a third aspect of the present disclosure, a microphone is provided which comprises at least one light source, a translucent sleeve in optical communication with the at least one light source such that when the at least one light source is energized, light generated by the at least one light source is visible from an outer surface of the translucent sleeve, and at least one of a capacitive sensor and an inertial sensor operatively connected to the at least one light source, wherein the at least one light source is energized in response to a sensor signal generated by the at least one of a capacitive sensor and an inertial sensor. In one example, a karaoke system is provided which comprises the microphone, a soundbar comprising at least one speaker, at least one wireless signal receiver, a processor, and a vocal effects module, wherein in response to a control signal received from the microphone, the vocal effects module applies a vocal effect to an audio signal received from the microphone.

In accordance with a fourth aspect of the present disclosure, a method of using a microphone is provided which comprises actuating an effects change control to select a vocal effect to be applied to an audio signal and varying the orientation of the microphone relative to the earth to thereby vary a vocal effect parameter corresponding to the vocal effect.

In accordance with a fifth aspect of the present disclosure, a method of using a microphone comprising at least one light source is provided. The method comprises gripping the microphone and altering an orientation of the microphone relative to the Earth, whereby the light source emits light.

In accordance with a sixth aspect of the present disclosure, a microphone wireless adapter is provided which comprises a shell comprising an open top, a closed bottom, and an opening extending from the open top to the closed bottom, a wireless transmitter disposed in the sleeve; . The wireless adapter also comprises a shell electrical connector configured for connection to an electrical connector on a microphone, wherein connecting the shell electrical connector to the electrical connector of the microphone places an acoustic-electric transducer of the microphone in electrical communication with the wireless transmitter.

In accordance with a seventh aspect of the present disclosure, an entertainment system adjustable between a karaoke microphone configuration and a gaming configuration is provided. The entertainment system comprises a microphone housing, an inertial sensor, a control unit operatively connected to the housing, a transceiver operatively connected to the control unit, a microphone capsule removably attachable to the housing and comprising an acoustic-electric transducer, and a gaming attachment comprising a translucent housing and at least one light source in the translucent housing, wherein the translucent housing of the gaming attachment is removably attachable to the microphone housing, and the control unit is operatively connectable to the at least one light source in the translucent housing.

In accordance with an eighth aspect of the present disclosure, a method of playing a musical instrument is provided. The method comprises providing a gaming controller having a translucent housing with a shape corresponding to the musical instrument, an inertial sensor, and at least one light source in the translucent housing, providing a base station operatively connected to a sound amplification system and the gaming controller, transmitting a control signal to the base station based on an inertial sensor signal generated by the inertial sensor, transmitting an audio signal from the base station to the sound amplification system, wherein the audio signal corresponds to the inertial sensor signal, and the musical instrument, and activating the at least one light source based on at least one of the inertial sensor signal and a control signal transmitted from the base unit to the gaming controller.

In accordance with an ninth aspect of the present disclosure, a gaming controller is provided that comprises a housing that includes a plurality of translucent housing segments that are foldable to define first and second housing configurations. One or more of the plurality of translucent housing segments includes one or more internal light sources. At least one capacitive or mechanical control switch is provided to energize the one or more internal light sources. .

### BRIEF DESCRIPTION OF THE DRAWINGS

FIG. 1 depicts an example karaoke system comprising a smart TV, a soundbar, and wireless microphones, wherein the system is controlled by a mobile phone application (also referred to herein as an "app");

FIG. 2 is a block diagram of an example karaoke soundbar controller used in the soundbar of the karaoke system of FIG. 1;

FIG. 3 is a block diagram of an example control system used in the karaoke microphone of the karaoke system of FIG. 1;

FIG. 4A is a schematic diagram of an example capacitive-based touch sensitive circuit used in the microphone of the karaoke system of FIG. 1;

FIG. 4B is a depiction of an example flexible printed circuit board with capacitive touch sensitive button regions and a button controller used in the microphone of the karaoke system of FIG. 1;

FIGS. 5A-B illustrate an example single-chip inertial sensor creating a 3-axis gyroscopic output based on solid-state accelerometers;

FIG. 6 is a schematic diagram of an example inertial sensor circuit for an inertial sensor comprising an accelerometer and magnetometer used to illustrate 'sensor fusion' for precise position and motion signaling;

FIG. 7 illustrates an example acoustic-electric transducer for a dynamic microphone;

FIG. 8 illustrates a first embodiment of an example karaoke microphone suitable for use in the karaoke system of FIG. 1 in which the microphone is configured to transmit control signals that are based on the orientation and/or movement of the microphone relative to the Earth;

FIGS. 9A-9B illustrate a second embodiment of an example karaoke microphone suitable for use in the karaoke system of FIG. 1, in which the microphone is configured to transmit control signals based on the orientation and/or movement of the microphone relative to the Earth and which includes capacitive touch sensitive switches configured to activate LEDs in the microphone housing;.

FIG. 10A is an illustration of an example soundbar suitable for use in the karaoke system of FIG. 1;

FIG. 10B depicts the microphone of FIGS. 9A and 9B in a first orientation relative to the Earth;

FIG. 10C depicts the microphone of FIGS. 9A and 9B in a second orientation relative to the Earth;

FIG. 11A is an illustration of the microphone of FIGS. 9A and 9B showing an example of the control buttons and the illumination scheme thereof;

FIG. 11B is an illustration of the microphone of FIGS. 9A and 9B showing example internal ambient lighting;

FIGS. 12A-B depict a third-embodiment of an example karaoke microphone suitable for use in the karaoke system of FIG. 1 and employing both mechanical pushbuttons and capacitive-touch switches;

FIGS. 13A-B depict close-up views of upper and lower portions, respectively, of the example karaoke microphone of FIGS. 12A-B;

FIGS. 14A-B depict an example of the microphone of FIGS. 12A-12B in two different orientations relative to the Earth and with two different illumination colors used to differentiate the users corresponding to each microphone;

FIG. 15A is an exploded view of the microphone of FIGS. 12A-B, illustrating example internal components of the microphone

FIG. 15B is a close-up view of an example circuit board of FIG. 15A showing a plurality of surface mounted LEDs used as a light source to illuminate the shell of the microphone;.

FIGS. 16A-D show various example illumination states of the karaoke microphone of FIGS. 12A-12B;

FIG. 17 shows example color transition steps and the time sequence of colors as a microphone body is cycling through colors in rainbow mode;

FIG. 18 shows an exploded view of an example upper portion of the microphone of FIGS. 12A-12B, highlighting the placement of an accelerometer inertial sensor which provides microphone spatial orientation data to the controller system of the soundbar system; .

FIG. 19A-D illustrates example internal illumination of the microphone of FIGS. 12A-12B as the microphone is handled by the user;

FIG. 20A shows a perspective view of an example of the microphone of FIGS. 12A-B in which the microphone housing is transparent to illustrate a microphone weighting system that causes the microphone to roll to a stop orientation in which the control buttons and display elements are always in view when the microphone is placed on a flat surface;

FIG. 20B is cross-sectional view of the example microphone of FIG. 20A in the stop position;

FIG. 20C illustrates a plurality of rotational orientations of the example microphone of FIG. 20A about a longitudinal axis of symmetry of the microphone housing relative to a flat surface on which the microphone is placed;

FIG. 21A depicts a user holding the example microphone of FIGS. 12A-12B and activating the inertial sensing feature for controlling an audio effect based on the orientation and/or movement of the microphone;

FIG. 21B depicts the example microphone of FIG. 20A on a table in an orientation in which the microphone is muted and unilluminated;

FIG. 22A depicts a user holding the example microphone of FIGS. 12A and 12B in a first spatial orientation of the microphone relative to the Earth;

FIG. 22B depicts a user changing the spatial orientation of the example microphone of FIGS. 12A-12B relative to the Earth to modulate a vocal effect applied to the singer's voice;

FIG. 23A is a top perspective view of an example charging base for a microphone useful in the karaoke systems described herein;

FIG. 23B is a bottom perspective view of the example charging base of FIG. 23A;

FIG. 23C is a perspective view of the example charging base of FIGS. 23A with two microphones installed in a charging configuration;

FIG. 24A depicts an example wireless-adapted karaoke microphone system comprising a controller sleeve adapted for connection to wired microphone shown in an uninstalled configuration in which the sleeve is detached from the microphone;

FIG. 24B depicts the example wireless adapted karaoke microphone system of FIG. 24A in an installed configuration with the controller sleeve installed on the microphone;

FIG. 24C depicts a perspective view of an example female XLR connector of the wireless-adapted karaoke microphone system of FIG. 2A

FIG. 24D depicts a perspective view of an example male XLR connector of the wireless-adapted karaoke microphone system of FIG. 2A.

FIG. 25 is an example block diagram of a karaoke microphone control system used in the wireless adapter shell of FIGS. 24A-B.

FIGS. 26A-E depict the example karaoke microphone of FIGS. 12A-12B with a removable microphone capsule and a variety of different sports-related gaming controller attachments;

FIGS. 27A-D illustrate example methods of use of the gaming controllers of FIGS. 26B-D;

FIGS. 28A-D illustrates an example far-field microphone implementation of the karaoke microphone of FIGS. 12A-12B and the charging base of FIGS. 23A-23B;

FIGS. 29A-C illustrate example musical instrument-themed gaming controllers with internal light sources and wholly or partially translucent housings;

FIGS. 30A-C illustrate examples of the user position and usage of the musical instrument-themed gaming controllers of FIGS. 29B-29D.

FIGS. 31A-C illustrate an example handheld, fitness gaming controller with an internally illuminated camera housing;

FIGS. 32A-C illustrate example usage of the fitness-themed gaming controllers of FIGS. 31A-31C;

FIGS. 33A-C illustrate an example embodiment of a cheering stick comprising the microphone of FIG. 12 modified to include an internally illuminated, translucent sphere;

FIGS. 34A-F illustrates three example variations of gaming controllers with internal light sources that transmit light through translucent portions of the controller housing;

FIGS. 35A-C illustrates two example variations of a left hand gaming controller and a right-hand gaming controller with internal light sources projecting light through translucent portions of the controller housing;

FIGS. 36A-D illustrates two example variations of foldable game controllers with internal light sources that transmit light through translucent portions of the housing; and

FIGS. 37A-C illustrate an example of a passive infrared sensor (PIR) integrated circuit with printed circuit board mounting and IR diffusion shield.

### DETAILED DESCRIPTION

This disclosure relates to handheld devices that transmit control signals and/or generate different lighting patterns in response to movement or being placed in particular geometric orientations relative to the Earth. In one example, a soundbar and microphone system with advanced features for the support of karaoke singers are provided. The system allows users to control audio effects and lighting of the microphone case through gestures detected by inertial sensors and/or capacitive sensors built into the microphone as well as by means of a smartphone application. The combination of elements adds significant and useful capability to the karaoke experience by introducing a karaoke soundbar with one or more intelligent microphones designed with sophisticated control features to enhance the capabilities of karaoke singers.

### Karaoke Soundbar

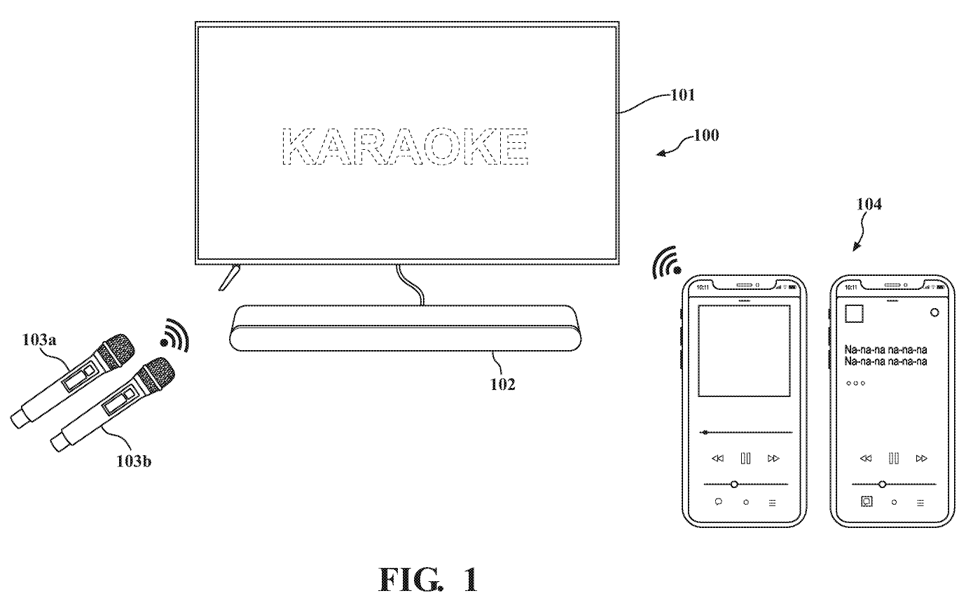

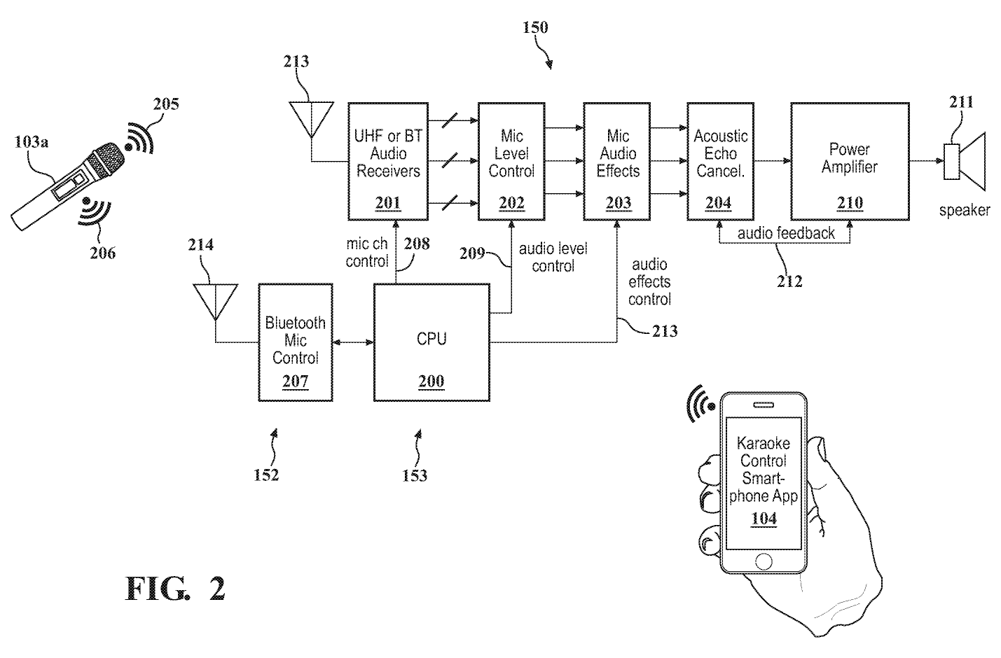

The karaoke soundbar 102, shown in FIG. 1, serves as the core element of the audio-visual entertainment system 100, which in FIG. 1A is a karaoke system. Audio-visual entertainment system 100 includes soundbar 102, microphones 103a and 103b, and video display 101. System 100 combines the input from multiple microphones (e.g. microphones 103a and 103b) with the chosen music source and plays the combined audio streams on soundbar 102, creating a balanced and immersive audio experience. Soundbar 102 includes at least one speaker, at least one wireless signal receiver (or transceiver), at least one processor, and a vocal effects module. FIG. 2 illustrates a karaoke soundbar controller comprising an advanced mixer and level controller 152 that includes an audio signal pathway a control signal pathway 153. Control signal pathway 153 enables programs executed by CPU 200 to apply various types of signal processing to an audio signal in the audio signal path 150 in correspondence to the particular control signals that are received from microphones 103a, 103b.

Referring to FIG. 2, the audio pathway 150 of soundbar 102 includes an RF receiver, namely UHF or Bluetooth (BT) Audio Receivers 201, a mic level control module 202, a mic audio effects module 203, and an acoustic-echo cancel module 204. Only microphone 103a is shown in FIG. 2, but it is understood that microphone 103a and/or additional microphones may also be used. These modules operatively and wirelessly connect to the microphone 103a and to power amplifier 210 and speaker 211, ensuring a clutter-free environment. An advanced mixer and level controller 152 balances audio levels and applies a range of audio effects, such as echo, reverb, chorus, flange, pitch shifting, and tone adjustments (i.e., bass and treble). The CPU 200 and power amplifier 210 (FIG. 2) work together to process and amplify the audio signals, delivering high-quality sound to the user. Additionally, soundbar 102 features dedicated controls for managing various audio effects, allowing users to customize their sound.

FIG. 2 shows wireless microphones 103a transmitting audio signal 205 in either the Bluetooth protocol or via a UHF band to soundbar 102. Although not shown in FIG. 2, microphone 103b would also transmit its respective audio signals to soundbar 102 in a similar fashion. In some implementations, the UHF band may be preferred as it provides a lower latency to the audio, which is preferred by karaoke singers. The microphone digital audio is received by antenna 213 built into the soundbar 102 which may be a patch or dipole antenna integrated into the case of the soundbar 102. The UHF or Bluetooth audio receivers 201 are implemented as one or more UHF or Bluetooth radios to individually receive transmissions from one or more microphone 103a, 103b. The outputs of radio receivers 201 may be serial digital streams utilizing the universal digital protocol for consumer electronics known as Inter-Integrated circuit Sound (IIS or more commonly I2S). All subsequent baseband (i.e.-unmodulated) interconnections between elements in the soundbar 102 as well as the microphones 103a, 103b of this disclosure may utilize the I2S protocol where appropriate.

The I2S digital audio protocol presents a data stream of 768,000 bits per second which is derived from the use of a 48,000 samples per second analog to digital conversion of the sound hitting the microphone when sampled at 16 bits per sample. This is a modest data rate easily managed by contemporary silicon devices as employed by this disclosure. In another embodiment, the microphone element could utilize pulse density modulation (PDM) outputting a serial data stream where the width of the pulse carries the audio information.

The one or more audio streams output by receiver 201 may be applied to mic level controller 202 where the individual levels of the received streams are controlled by the CPU 200 in response to received control signal inputs from the microphones 103a, 103b (not shown in FIG. 2). The control signals 206 may be Bluetooth signals generated by the user's pressing up ("+") and down ("-" ) buttons on the microphone 103a body. The transmitted control signals 206 are received at the soundbar 102 by control signal antenna 214 and then by Bluetooth controller 207. Note that, in some implementations, when Bluetooth is used for audio transmission from the microphone 103a instead of UHF, control signal antenna 214 is not used and all signals (i.e., including both audio and control signals) to and from the microphone 103a are received by (or transmitted by) antenna 213. Where Bluetooth audio signals are used, audio receiver 201 is a Bluetooth audio receiver, and the Bluetooth standard distinguishes between control signals and audio signals received by antenna 213. In that case, audio receiver 201 would transmit the received control signals to CPU 200 for use by programs executed by CPU 200.

The output from mic level controller 202 can then applied to mic audio effects module 203 where the respective control signals 206 from each mic 103a, 103b are applied such as when the user presses buttons on the microphone to increase or decrease bass or treble or when the singer wants more or less echo applied to their respective voices. As with volume, the control signals from the microphones may be received via the Bluetooth mic controller 207.

The output of the mic audio effects module 203 is applied to acoustic echo cancellation module 204. This echo cancellation process may be useful to the karaoke soundbar system 100 to reduce feedback from the speaker back into the respective microphone, such as when both the speaker and the one or more microphones are in close proximity to each other and thus prone to feedback. Acoustic echo cancellation may involve applying audio feedback from the audio amplifier 212 among other inputs. The output of the power amplifier 210 is then applied to one or more speakers 211 of the soundbar apparatus.

The smartphone app 104 may provide the karaoke singer with a means to set initial conditions of the system such as tone control (bass and treble), echo, reverb, delay, flange, pitch shifting, or chorus effects. As discussed in greater detail below, these configurations can be controlled during a performance by means of touch sensitive controls on the body of the microphone 103a the karaoke system 100. The app 104 can also configure lighting effects visible through the microphone case as described below.

### Intelligent Microphone

The intelligent microphones of the disclosure comes in multiple embodiments, each offering unique capabilities to enhance the karaoke experience. As discussed further below, certain of the karaoke microphones described herein include capacitive switches, selective internal illumination that is visible from outside the microphone body and which conveys information about the controls and/or state of the microphone, and inertial sensors that may be used to activate, deactivate, or modulate vocal effects.

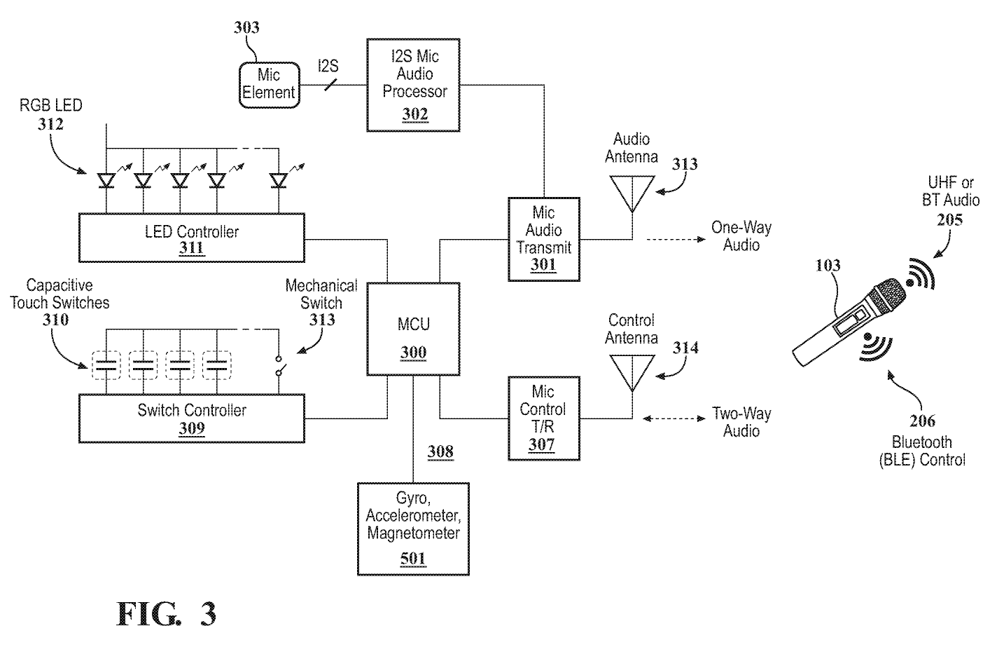

To varying degrees, FIG. 3 illustrates a block diagram of the internal processing of each karaoke microphone 103a, 103b of the present disclosure (only microphone 103a is shown). Each microphone 103a, 103b includes an acoustic-electric transducer to convert acoustic sound waves into electrical signals. In one embodiment a MEMS microphone element 303 is utilized which converts air pressure on a membrane into a PDM digital audio stream output which is connected to a mic audio processor 302. Mic audio processor 302 supplies a sample clock to the MEMS element 303 as part of the PDM specification. The output of mic audio processor 302 is applied to mic audio transmitter 301 and transmitted to the soundbar system via antenna 313 which may be a printed circuit antenna (also known as a patch antenna). The MCU (microcontroller unit or control unit) 300 controls the transmission of the digital audio stream from mic audio processor 302 via the mic audio transmission module 301. The control functions of MCU 300 may include selection of channel frequency or subchannel selection based on the choice of transmission protocol which is a well understood process to the skilled person. Another function of the mic audio transmission module 301 is to mute the audio when either commanded by a control transmission from the karaoke soundbar controller of FIG. 2 or by command of the karaoke singer depressing the mute button on the microphone 103a, 103b or by the state of the microphone 103a, 103b as detected by MCU 300. A mute-state detection by MCU 300 may be when the mic is detected to be horizontal and not in motion as when placed on a flat surface or when not in service as when detected to be placed on a recharger stand.

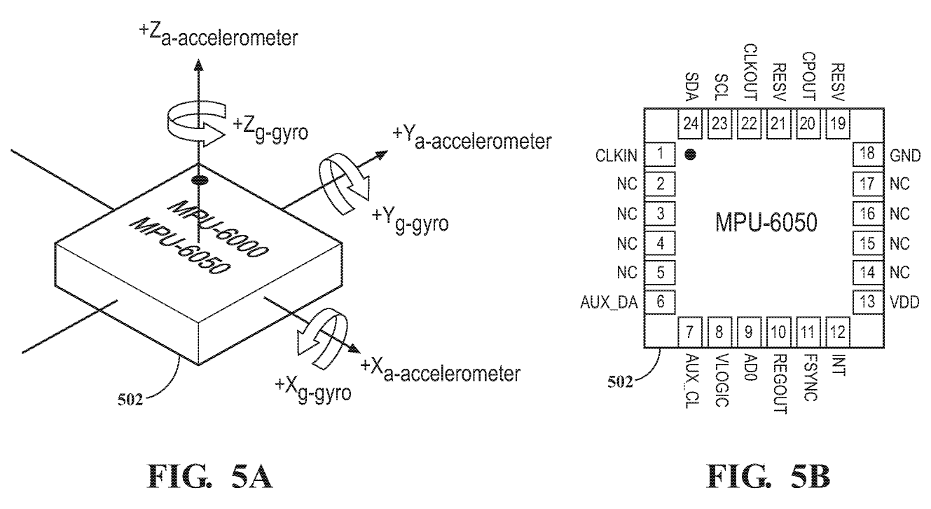

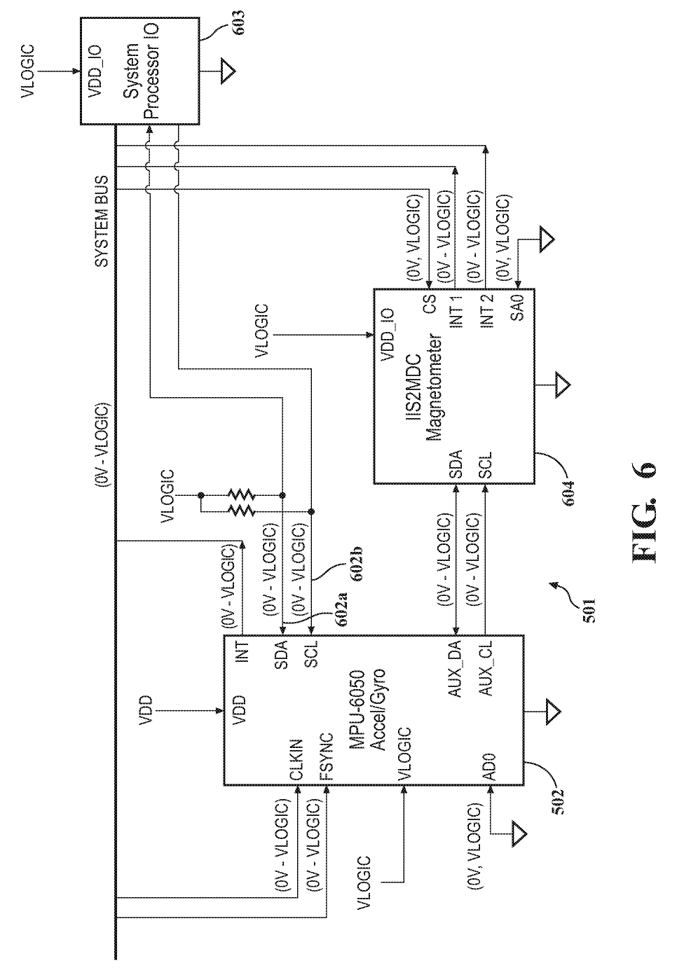

Motion and orientation detection of each microphone 103 a, 103b are provided by an inertial sensor 501 which communicates acceleration, change in direction, and absolute direction information of the corresponding microphone 103a or 103b as an inertial sensor signal 308 to MCU 300 via one or more integrated circuits especially designed for this task. The inertial sensor 501 may comprise an accelerometer 502 shown in FIGS. 5A and 5B. Accelerometer 502 senses changes in motion (gyro) of the microphone 103 a, 103b body as well as changes in the rate of change of motion (acceleration). The signals from inertial sensor 501 provide information to the MCU 300 which are then utilized by the software of the MCU 300 to activate visual effects on display 101 as well as to provide audio effects on the user's audio stream such as increases or decreases in volume, echo, reverb, or chorus depth wherein such increases or decreases are proportional to extent of the motion (e.g. displacement, degree of rotation, velocity, and/or acceleration) of the corresponding microphone 103a or 103b. In certain examples, inertial sensor 501 for either or both of microphones 103a and 103b may comprise an accelerometer/gyrometer IC 502 and, additionally, a magnetometer IC 604 (FIG. 6). Magnetometer IC 604 is essentially a digital compass. In combination with accelerometer ICs 502, magnetometer ICs 604 serve a useful role in enhancing the overall sensing capabilities of devices by providing information about the Earth's magnetic field. Specifically, in the context of this disclosure, magnetometer ICs 604 are used for improved motion tracking via a process known to the skilled person as 'sensor fusion' in which magnetometer IC 604 data is combined with accelerometer and gyroscope 502 data. This sensor fusion process allows more precise motion tracking and orientation estimation, especially in situations where the accelerometer or gyroscope alone might be unreliable (e.g., during slow movement of the microphone 103a, 103b). One suitable and commercially available accelerometer 502 is an MPU-6050 (FIG. 5B) supplied by InvenSense. One suitable magnetometer 604 is the 11S2 MDC magnetometer supplied by STMicroelectronics.

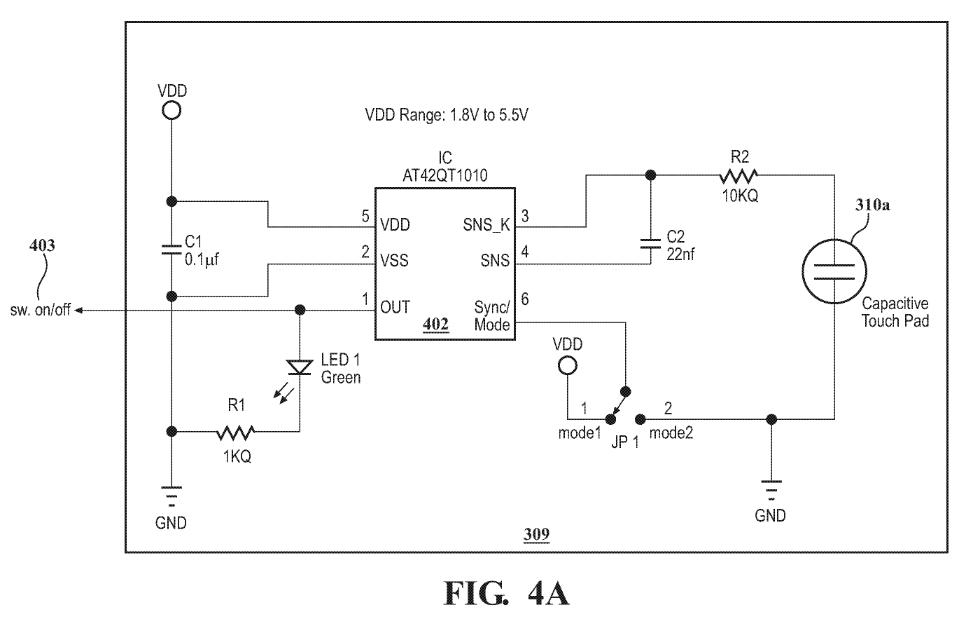

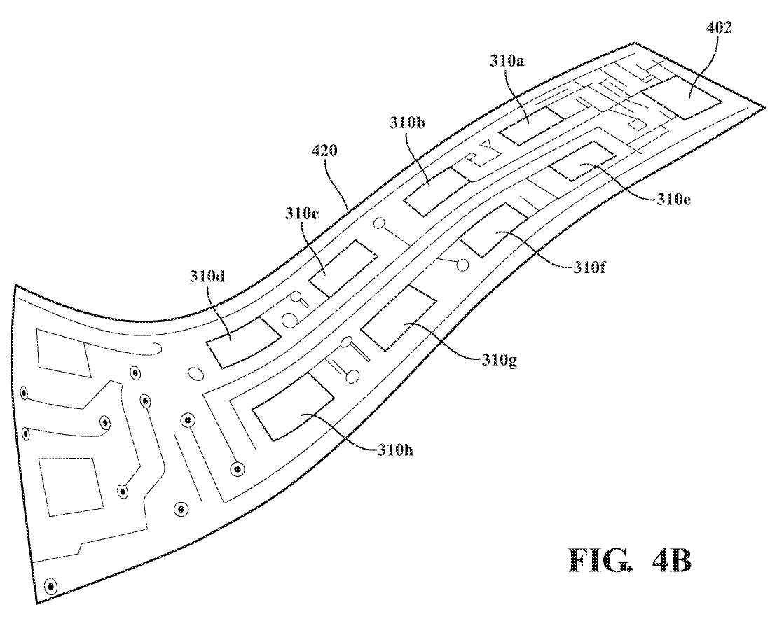

Referring again to FIG. 3, switch controller 309 monitors both capacitive as well as mechanical switch activations and reports the switch states to the MCU 300. A schematic of a capacitive switch monitoring circuit is illustrated in FIG. 4A. In this diagram a dedicated IC 402 is shown monitoring a single capacitive switch touch pad 310a for the purposes of illustration only. In a practical circuit such as in the body of a multiple touch switch environment of a karaoke mic, this dedicated IC 402 would be able to monitor a multiplicity of capacitive touch pads like touch pad 310a in a single chip via a scanning means that steps through each switch contact area to detect the capacitive switch states of each switch in sequence at a rate faster that human motion. This multiplexing process is well known to the skilled person. The illustration of FIG. 4A shows a flexible printed circuit board (PCB) 420 containing a plurality of such capacitive touch switch areas 310a-310h monitored by a single control IC 402 as illustrated in FIG. 3.

In certain examples herein, karaoke microphones 103a, 103b each have a translucent case or housing that houses one or more LEDs to illuminate the case and provide visual feedback for many purposes. The individual LED may be of the tri-color variety containing a red, green, and blue LED on a single chip, allowing the output of any color in the visible spectrum by varying the relative intensities of red, green and blue. In one example, when microphones 103a, 103b are placed in a charger stand, one or more LEDs can be illuminated to show relative completeness of a full charge of the battery during the charging cycle. During performances, the LEDs can also be used to indicate one or more states (e.g., audio control states, acceleration states, orientation states) of the microphone 103a, 103b as detected by its respective MCU 300. For example, if the microphone 103 a, 103b is detected by inertial sensor 501 to be horizontal and not in motion, the LEDs can be illuminated to indicate that the microphone is in a standby state. The LEDs can also be used to provide visual feedback to the audience whereby the LEDs change color or change brightness in relation to the volume of the singer's voice or in relation to the frequency range of the signer's voice, or in relation to both simultaneously. The control of one or more LEDs may be achieved with an LED controller 311 (FIG. 3) which applies current to the RGB elements of the LED of one or more LEDs under the control of MCU 300 in a process well known to the skilled person.

### First Embodiment of the Microphone

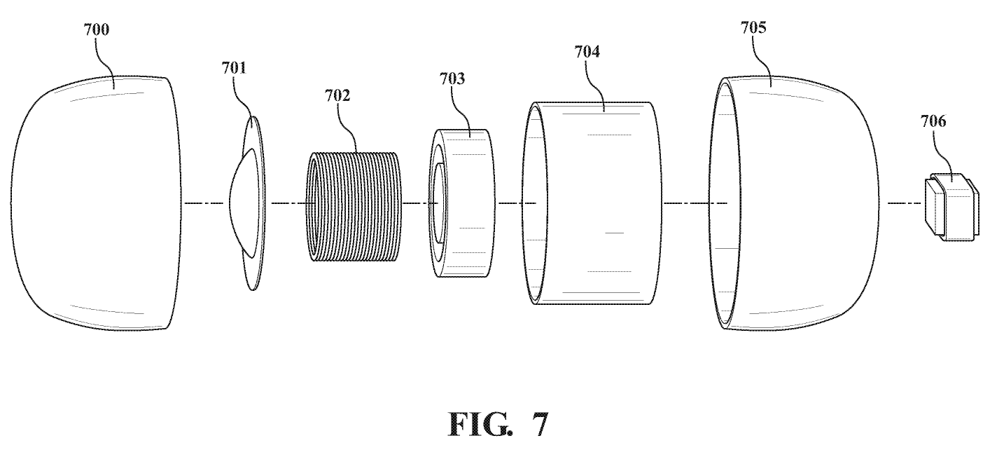

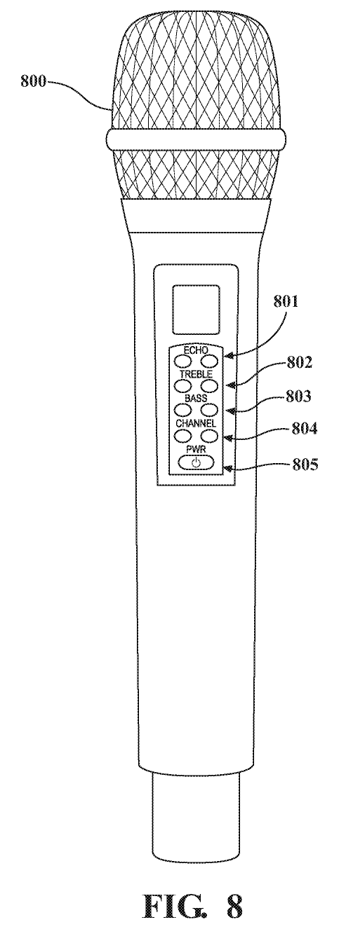

Referring to FIG. 8, an embodiment of a karaoke microphone 800 is shown. This embodiment features multiple sets of push-buttons to change volume 801, echo 802, treble 803, bass 804, and channel 805. It allows the user to dynamically alter the audio effects directly on the microphone during a performance by depressing the respective key on the body of the microphone. Microphone 800 does not include a translucent housing. However, it preferably includes an inertial sensor 501 of the type described previously operatively connected to a control unit. In one example, microphone 800 includes all of the elements of FIG. 3 except that switch controller 309 is not operatively connected to capacitive switches 310. Rather, switch controller 309 is operatively connected to push buttons 801-804 (FIG. 8). In addition, MCU 300 is operable to execute audio effects change algorithms that activate, deactivate, and/or modulate audio effects such as volume, reverb, echo, delay, pitch-shifting, chorus and flange based on and/or in proportion to a signal from inertial sensor 501, which in a preferred example includes both a gyrometer/accelerometer 502 and a magnetometer 604. A non-transitory computer readable medium having executable instructions stored thereon is preferably operatively connected MCU 300 to carry out such control functions.

In certain examples, the audio effects control algorithms executed by MCU 300 generate control signals that cause soundbar 102 to modulate the extent of a particular effect based on a selected orientation of microphone 103 a, 103b relative to the earth and/or based on the movement (acceleration) of microphone 103a, 103b. For example, starting from a reference orientation (which may be user selected) of microphone 103a, 103b relative to the earth, as the microphone 103 a, 103b moves farther from the reference orientation in a particular direction, the volume of the audio signal from microphone 103a, 103b may be increased. In another example, the orientation and/or movement of the microphone 103a, 103b may be used to modulate certain vocal effects parameters like the amount of reverb, the number of steps in a scale for pitch shifting, the delay time, the rate and/or depth of chorus or flange, or the percentage of the signal that is "wet" versus "dry" (i.e., the percentage of the signal that is subjected to or which bypasses the effect). In certain examples, a value of a control signal corresponding to the desired effect varies with a value of inertial control signal 308 from inertial sensor 501. In other examples, the orientation of the microphone is defined by an angular orientation of the microphone 103a, 103b relative to the Earth. In certain examples, MCU 300 can execute a local program to determine the desired changes to the vocal effect based on a inertial sensor signal 308 (FIG. 3) and transfer a corresponding control signal to soundbar 102 while in other examples, microphone 103a, 103b may just transmit the inertial sensor signal to soundbar 102 such that soundbar CPU 200 can execute a local program to determine the desired changes to the vocal effect.

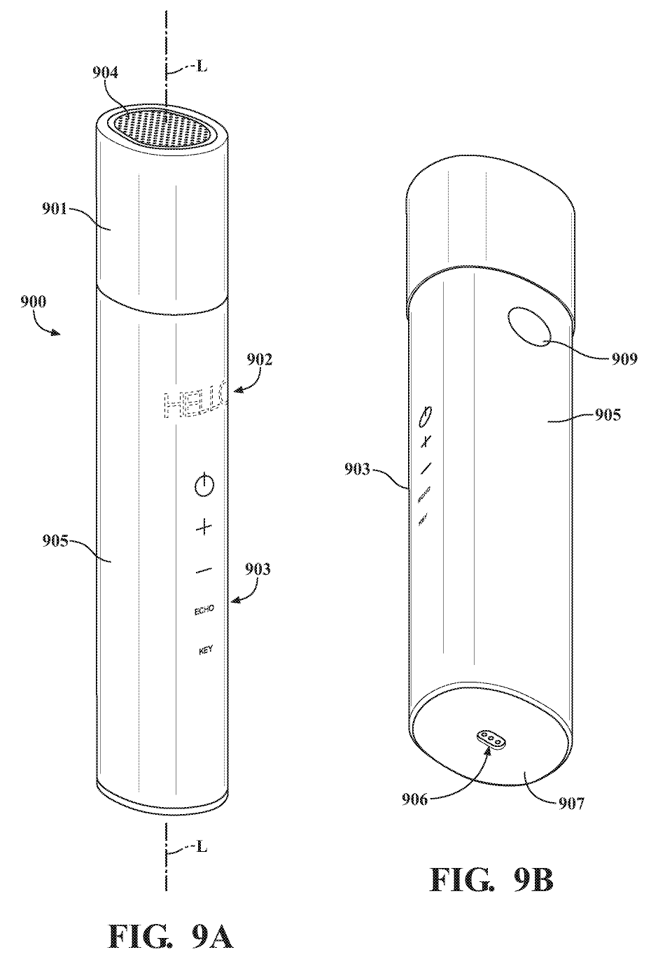

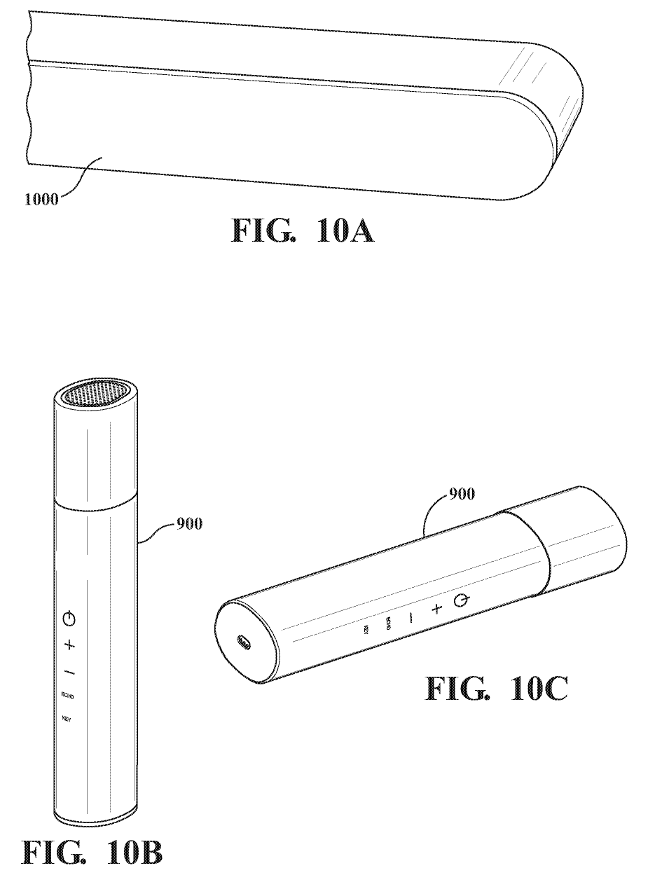

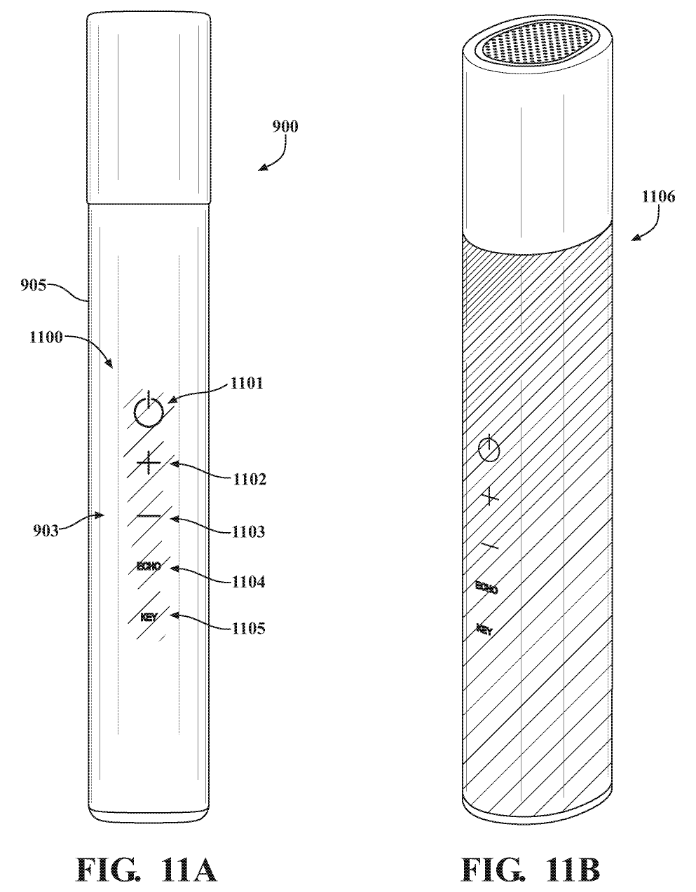

A second embodiment of a karaoke microphone 900 in accordance with the present disclosure is shown in FIGS. 9A-9B, FIGS. 10B-C, and FIG. 11B. Microphone 900 preferably has an internal set of components and modules in accordance with FIG. 3. Microphone 900comprises a perforated metal panel 904,a fabric grille 901,a dot matrix display 902,a sleeve 905a capacitive (touch sensitive) control button region 903,and effects change control button 909. Bottom cap 907is also provided and accommodates pogo pins 906for charging mic 900. An acoustic-electric transducer (not shown) is also provided within sleeve 905and/or fabric grille 901 to convert soundwaves into electrical signals.

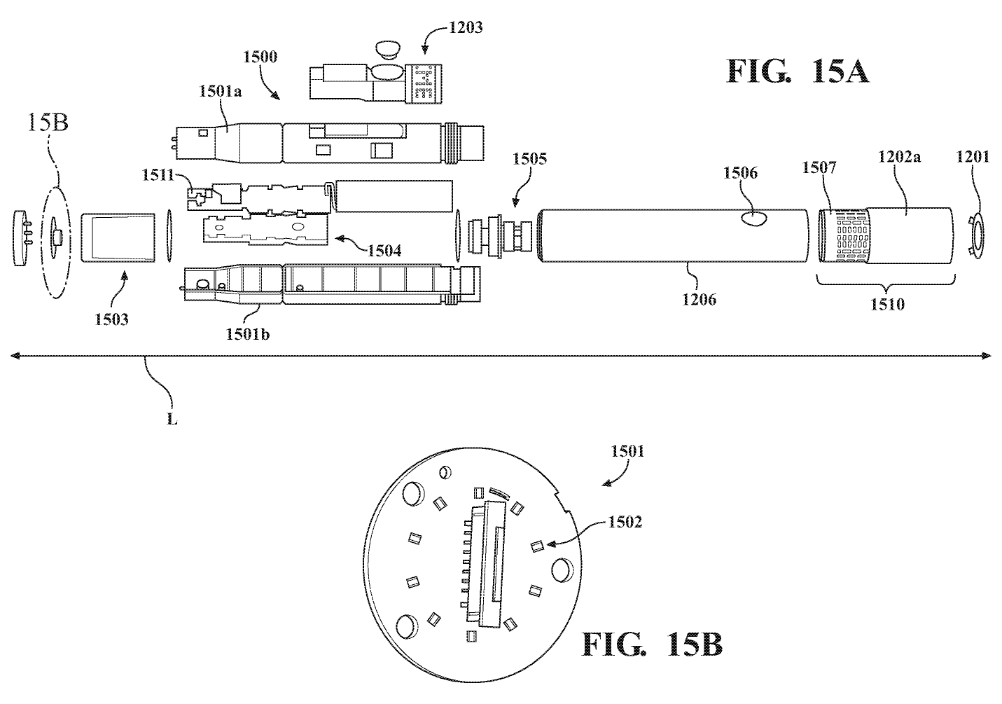

Microphone 900 also comprises a rigid or semi-rigid plastic housing 1500 (FIG. 15A) defined by two cooperatively mateable shells 1501a and 1501b. Sleeve 905 is formed from a rigid or semi-rigid plastic and fits over housing 1500 (in place of sleeve 1206 shown in FIG. 15A). In one example, sleeve 905 has an inner surface that comprises printed circuit board 420 (FIG. 4B) or on another substrate printed on the inner surface of sleeve 905. The capacitive touch switch areas 310a-310h are preferably conductive and generate a change in capacitance when a user's finger is nearby, as the combination of the switch area 310a-310h, the user's finger, and the air in between effectively define a capacitor with an air dielectric layer.

With the PCB 420 structure of FIG. 4B, the outer surface of sleeve 905 of microphone 900 is effectively touch-sensitive in the area of capacitive sensing regions 310a- 310h, adding an additional layer of interactivity. However, in certain examples, whenever the microphone 900 is held, the touch monitor circuitry defined on PCB 420 -- or on an adjacent PCB between the inner surface of sleeve 905 and housing 1500 -- activates, and the microphone 900 remains on, transmitting audio via audio antenna 313 (FIG. 3) to the soundbar audio signal receiver 201 and transmitting control signals via control antenna 314. In such cases, one or more LEDs 312 (FIG. 3) within the microphone 900 may be energized to transmit light through sleeve 905 as shown in FIG. 11B (the shading indicates light transmitted through sleeve 905). The adj acent PCB may be entirely touch sensitive and extend along the length of microphone 900 and around the portion of the circumference of microphone 900 that is outside of PCB 420 so that anytime a user handles microphone 900 anywhere along the length of microphone 900, a capacitive sensing signal is generated, while the individual control icons in control region 903 would also be selectively illuminated by user touching them with a finger.

As best seen in FIG. 9A, control button region 903 may be defined along a portion of the length of sleeve 905. Control button region 903 comprises a plurality of graphical symbols formed along the inner surface of mic sleeve 904, such as by molding. Five such symbols are shown in FIGS. 9A and 11A. Each graphical symbol is associated with a capacitive sensing region (like any of capacitive sensing regions 310a-310h in FIG. 4B) and one or more LEDs. When a particular capacitive sensing region 310a-310h generates a signal indicative of a threshold change in capacitance, a corresponding control function is executed by MCU 300 (FIG. 3) and one or more LEDs located proximate to the corresponding graphical symbol are illuminated.

In the example of FIG. 9A, if a user grips the sleeve 905 while microphone 900 is untouched and horizontal (FIG. 10C), dot matrix display 902 will illuminate. If the user puts microphone 900 down after holding it in an upright orientation (FIG. 10B), after a predetermined period of time in the horizontal orientation of FIG. 10C, the dot matrix display will cease to illuminate. Dot matrix display 902 acts as a user engagement indicator and comprises a plurality of LEDs arranged in a desired pattern, which in FIG. 9A defines the word HELLO. The sleeve 905 is preferably unmodified in the area of dot matrix display 902. Rather, LEDs may be provided and selectively illuminated to spell out different words such that the illuminated letters are visible from the outer surface of sleeve 905.

In control region 903 (FIG. 11A), button 1101 is used to selectively supply or

In control region 903 (FIG. 11A), button 1101 is used to selectively supply or terminate the supply of power from an internal power source (e.g., a battery) to the microphone 900 components, in particular, power to the LEDs 312 (FIG. 3) and the microphone's transmitter 310 (FIG. 3). Increase button 1101 is used to increase an audio effect parameter value (e.g., volume, delay time, chorus rate, flange depth, etc.) applied to the audio signal transmitted from mic 900 to receivers 201 (FIG. 2). Decrease button 1102 is used to decrease an audio effect parameter value applied to the audio signal transmitted from mic 900 to receivers 201. In FIG. 11B, mic 900 has been grabbed by a user (not shown), causing an internal LED array to illuminate and transmit light through sleeve 905 along its length. In FIG. 11B, each individual control button 1101-1106 may be illuminated. In an implementation, only the control button 1101-1106 that is currently active is illuminated.

Control buttons 1101-1105 (see FIG. 11A) in control region 903 may be used to activate/deactivate/modulate certain effects (e.g., echo and music key). However, effects change control button 909 (FIG. 9B) allows a user to selectively activate other effects (e.g., reverb, chorus, pitch shift, and flange) which may then be modulated using increase 1102 and decrease 1103 buttons. In the example of FIG. 9B, effects change control button 909 is a physical push button. However, it could also be a touch-sensitive button.

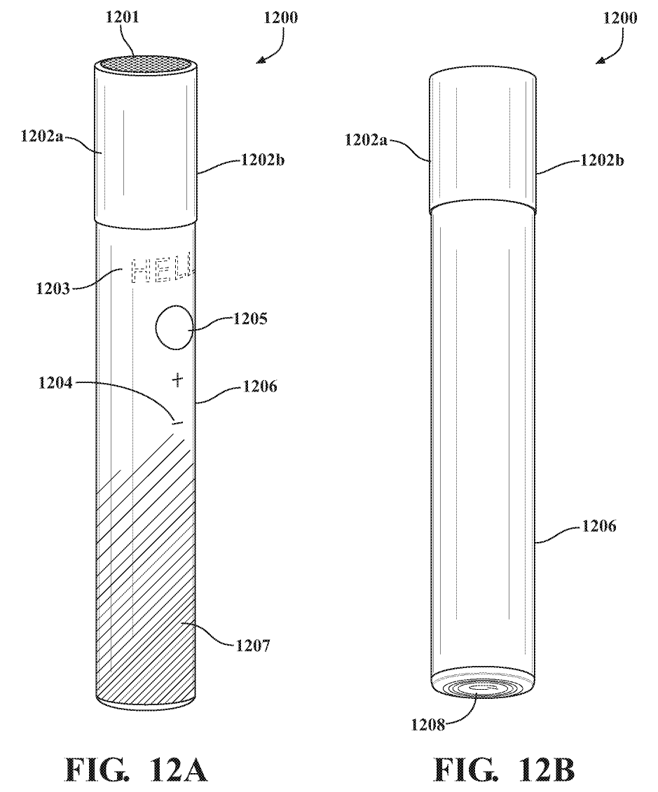

In certain examples, the movement and/or orientation of microphone 900 relative to the Earth may be used to modulate a desired vocal effect. In accordance with such examples, an initial engagement of effects change control button 909 causes a current value of an inertial sensor signal 308 from an inertial sensor 501 (FIG. 3) is stored. The corresponding orientation of mic 900 relative to the Earth at that point acts as a reference orientation. Any subsequent movement and/or of the microphone 900 relative to the reference orientation modulates the corresponding vocal effect by an amount that depends on the extent of the movement relative to the reference orientation. If desired, the speed at which the modulation occurs and/or the degree of modulation may also be varied with an acceleration of the mic 900 as it is moved. As an example, if a singer holds the microphone 900 vertically and presses the effects change control button 909 until a desired effect (e.g., chorus) is selected, once effects change control button 909 is released for a specified period of time, a reference orientation corresponding to an angle of 90 degrees between the length axis L of microphone 900 and the Earth may be stored. If the user then tilts his or her head back, the rate or depth parameter of the chorus may increase in proportion to the change in angle between the length axis of microphone 900 and the Earth. Any other vocal effect parameter may be similarly used and modulated. However, unlike the example of FIGS. 12A-B (discussed further below), microphone 900 has some vocal effects that are selectable by touching a corresponding capacitive switch and which can be modulated using the "+" and "-" buttons.

### Third Embodiment of the Intelligent Microphone

The third embodiment of the microphone 1200 is shown in FIGS. 12A-15A. This embodiment enhances the aesthetic appeal and user customization options. It features ambient lighting effects that provide visual feedback and create a dynamic atmosphere while the user is singing. Control region 1204 differs from control region 903 of FIGS. 9A and 9B in that the former has only increase ("+") and decrease ("-") buttons and does not include buttons for selecting particular effects. Thus, effects change button (or "mode button") 1205 may be pressed repeatedly to cycle through and select an effect from among a plurality of vocal effects.

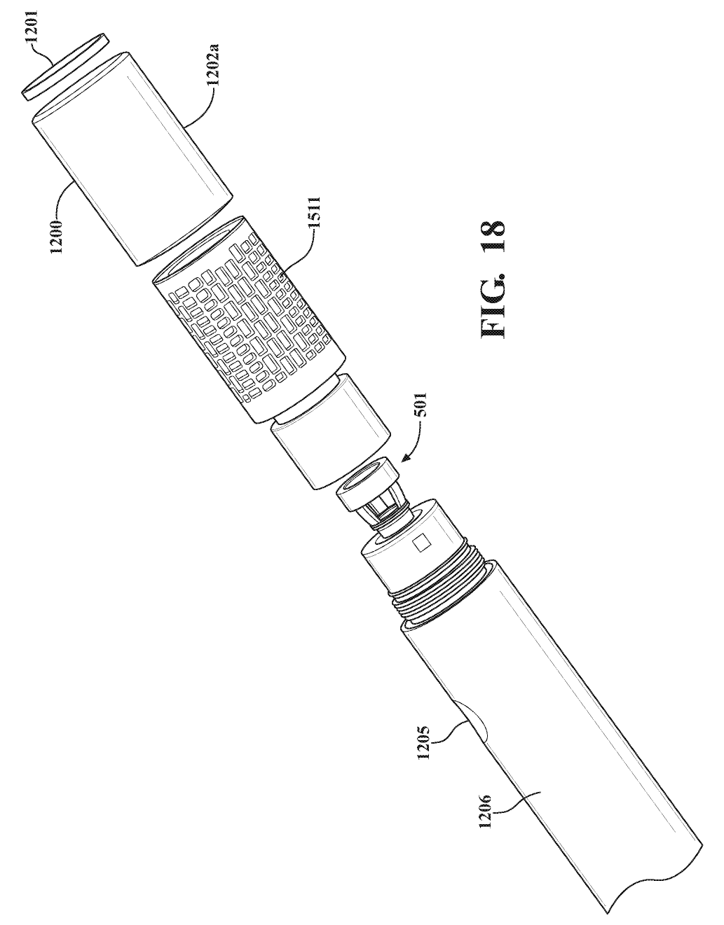

As shown in FIG. 18, in certain preferred examples, microphone 1200 includes an inertial sensor 501 which may include the circuitry of FIG. 6 or an equivalent single chip variation. Thus, in certain examples, an inertial sensor signal 308 (FIG. 3) from inertial sensor 501 (FIG. 18) would be used by a program executed by MCU 300 to determine the extent of modulation of a parameter for a vocal effect. Thus, in the case of a delay, the inertial sensor signal may dictate the delay time applied to the audio signa or the amount of wet versus dry signal. In the case of a chorus effect, the rate and/or depth parameters may be varied based on the inertial sensor signal 308. In another example, soundbar CPU 200 receives the inertial sensor signals and executes a program to determine the corresponding audio effect parameter modulation.

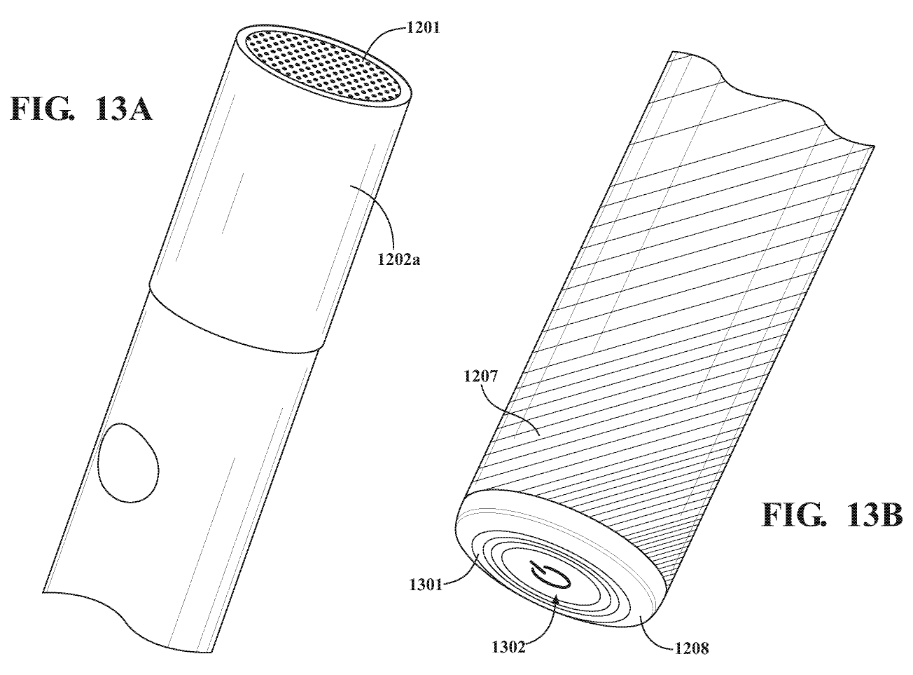

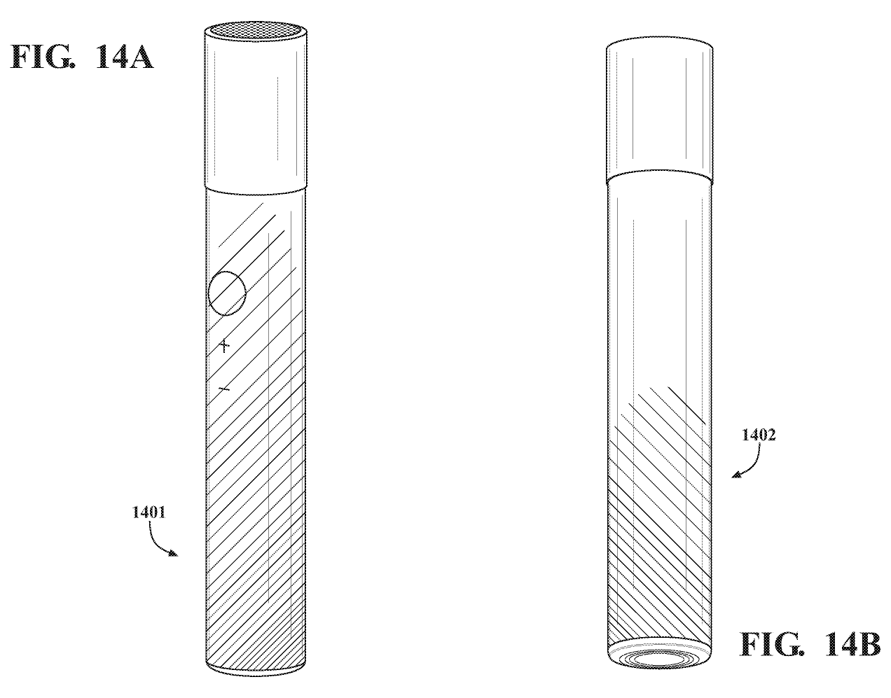

Microphone 1200 is designed with a removable and replaceable fabric grille 1202a (FIG. 12A) comprising perforated metal panel 1201 and removable mic fabric assembly 1202b, allowing users to personalize their microphone. Mic sleeve 1206 is similar to mic sleeve 905 of FIGS. 9A-9B and has a printed circuit board similar to PCB 420 (FIG. 4B) on its inner surface with capacitive sensing regions similar to regions 310a-310h shown in FIG. 4B. Touch control button region 1204 is configured similarly to touch control button region 903 of FIGS. 9A-B, and dot matrix display 1203 is configured similarly to dot matrix display 902 of FIGS. 9A-B. Ambient light region 1207 is a region of sleeve 1206 through which light is transmitted whenever the mic 1200 is held in a user's hand. In FIG. 12B, no light is transmitted from ambient light region 1207. In preferred examples, the illuminated length of ambient light region 1207 depends on the volume of the singer's voice. The ambient lighting can also be customized through the smartphone app 104 (FIG. 1A), offering a range of colors to suit different moods and settings. In addition, when there are multiple singers, each singer can choose an individual color as illustrated in FIGS. 14A and 14B (the two different shading patterns represent distinct colors, each of which corresponds to a respective singer). Also, LED array 1502 (FIG. 15B) may illuminate microphone 1200 to a short distance along the length of microphone 1200 when the microphone 1200 is gripped by a user even when the user is quiet and providing no acoustic input to microphone 1200 and then the brightness and/or length of the light path along the interior of microphone may increase in direct relation to the volume of the user's voice. FIG. 13A shows a close-up perspective view of the top of microphone 1200. FIG. 13B shows a close- up perspective view of the bottom of mic 1200 with ambient light section 1207 illuminated. A bottom cap 1208 encloses the bottom of sleeve 1206 and includes charging coils 1301 and a power button 1302.

FIGS. 15A-B show an exploded view of microphone 1200. A removable microphone capsule 1510 includes acoustic-electric transducer housing section 1507 and microphone fabric grill 1202a (described previously). Acoustic-electric transducer 1505 sits in acoustic-electric transducer housing section 1507 and within sleeve 1206 when the microphone 1200 is assembled.

Sleeve 1206 fits over housing 1500, comprising housing half-shells 1501a and 1501b which are mateable to define an internal cavity that houses printed circuit board 1511 and anti-rolling weight 1504. Printed circuit board 1511 is contained within the half-shells 1501a and 1501b and would include the circuitry of FIG. 3 with the exception of LED controller 311 which is provided on PCB 1501 at the bottom of the microphone (FIG. 15B). As discussed further below, an anti-rolling weight 1504 is also contained within housing half-shells 1501a and 1501b.

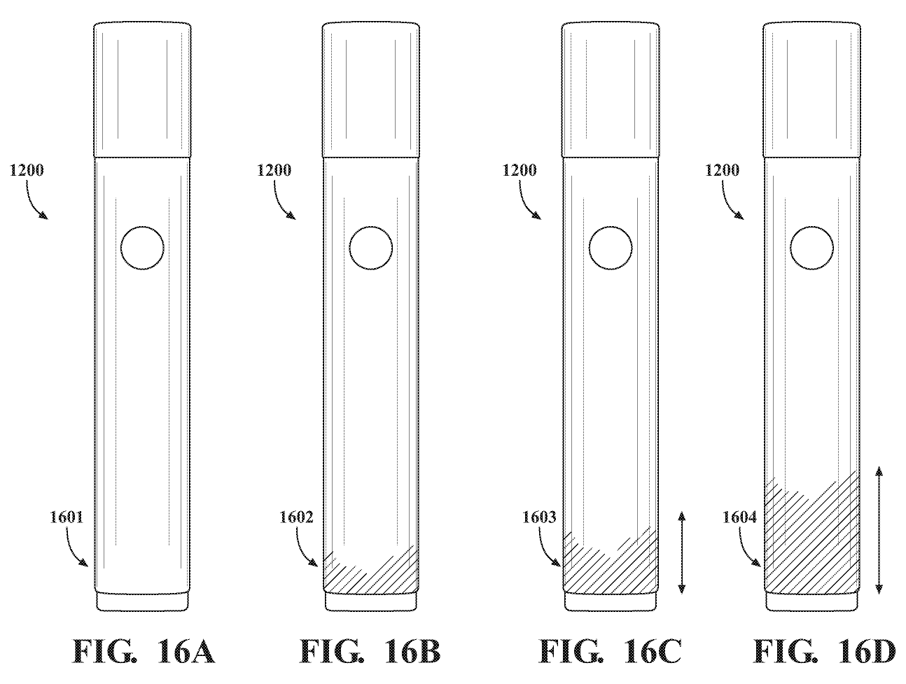

Ambient light guide 1503 is a cylindrically-shaped light guide in optical communication with LED array 1502 on printed circuit board 1501. Light guide has a first end that receives circuit board 1501 and a second end spaced apart along the length of housing 1500. Light guide 1503 transmits light from LED array 1502 along the length axis L of housing 1500. In certain examples the LED array 1502 can be used as an indicator of singing volume. As shown in FIGS. 16A-16D, LED array 1502 generates light of varying intensities based on the volume of the singer's voice received by microphone 1200. In FIG. 16A, the user is not singing or is singing below a detectable or specified volume threshold, and no LED light is emitted. In FIGS. 16B-16D, the distance of travel of light from LED array 1502 along light guide 1503 and the length axis L of the microphone 1200 increases as a function of the singer's volume. In another example shown in FIG. 16A, no user is gripping microphone 1200, and in FIG. 16B the displayed illumination results when a user is gripping the microphone 1200 but is not singing or otherwise providing any acoustic input. Thus, the microphone 1200 is illuminated to a short distance along the length of the microphone. Then, when the user begins singing the length of light generated along the body of the microphone 1200 will vary with the acoustic volume of the singer's voice as shown in FIGS. 16C and 16D.

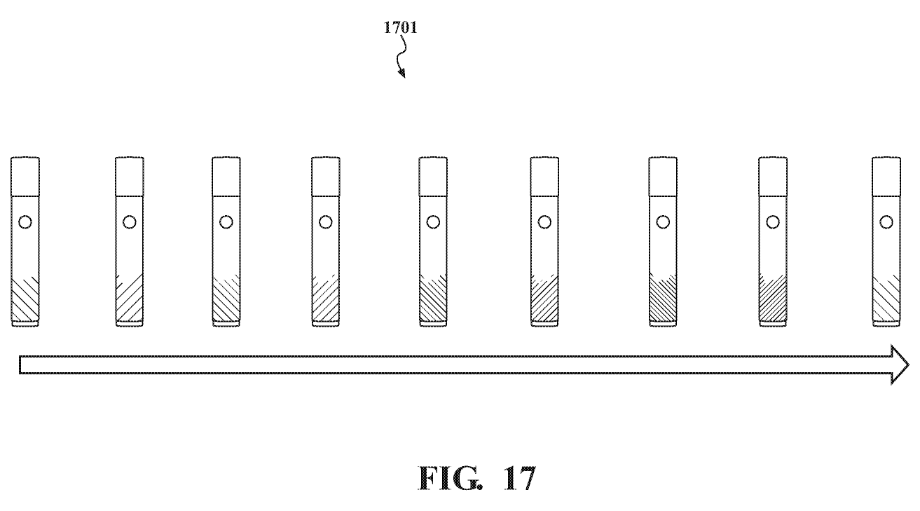

In certain examples, LED array 1502 is capable of generating different colors of light. For example, LED array 1502 may comprise an array of RGB LED packages, with each RGB LED package including each of a red, green, and blue LED. As the relative voltages applied to each individual LED in each package are changed, the relative intensities of red, green and blue in each RGB LED package will change, and hence, so will the aggregate color produced by the package. In certain examples, the color can be selected by the user using a smartphone app 104 (FIG. 1), allowing different users to keep track of their microphones based on the emitted color of light. The smartphone app may be used to initiate various aesthetically pleasing illumination schemes. For example, and as shown in FIG. 17, the smartphone app 104 (FIG. 1A) may be used to initiate (e.g., via a control signal from the smartphone app 104) a program executed by MCU 300 that causes LED array 1502 to cycle through a plurality of different LED colors.

### Microphone Dynamic Control

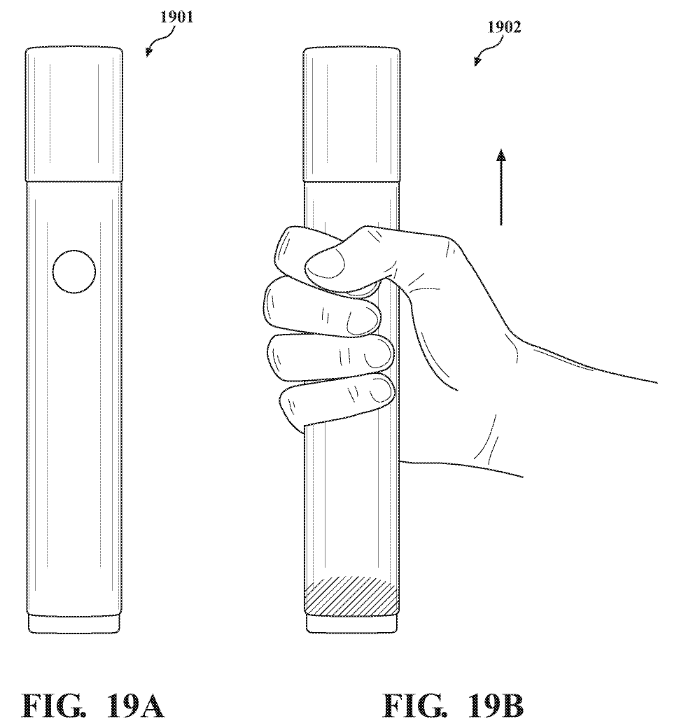

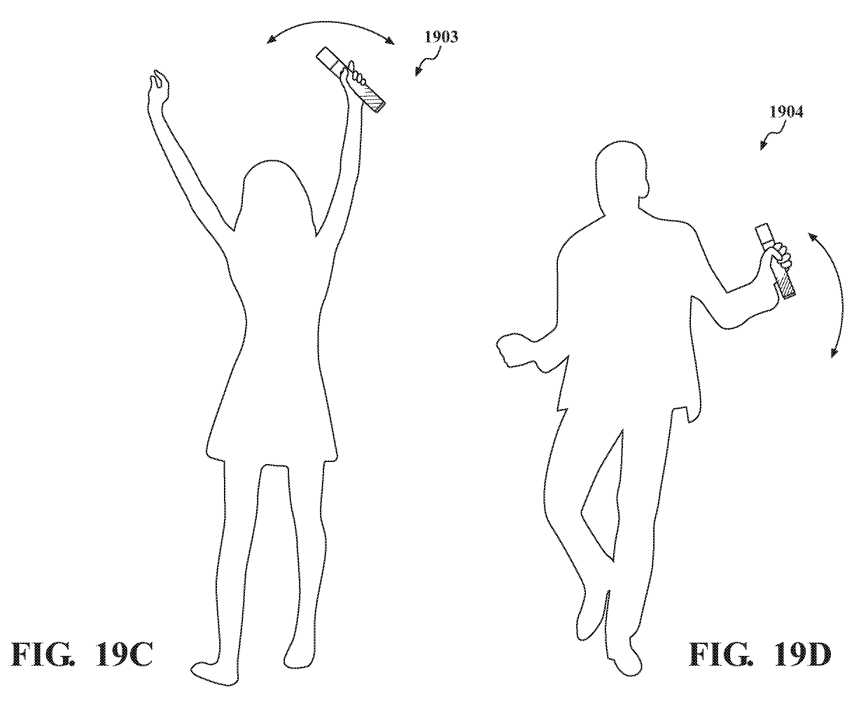

One aspect of the karaoke system 100 is dynamic control of audio effects through inertial sensing. As mentioned previously, an inertial sensor signal 308 (FIG. 3) may be used to modulate a vocal effect applied to an audio signal transmitted by microphone 1200. The color that is generated by LED ring 1502 and/or the pattern of its generation (e.g., steady pattern, ON/OFF at different frequencies) may be varied based on and/or synchronized to inertial sensor signal 308 (FIG. 3) generated by inertial sensor 501 (FIG. 18) in response to the movement and/or orientation of microphone 1200. The light pattern may also be synchronized to music using control signals transmitted from soundbar 102 to microphone 1200. In the examples of FIGS. 19C and 19D, user 1903 and user 1904 have their own respective colors assigned to their microphones and the light generated by LED array 1502 in each of their respective microphones is synchronized to the movement of their corresponding microphone.

In addition, inertial sensor signal 308 may be used to vary aspects of the illumination of the LEDs comprising LED ring array 1502. An example of light changes relative to position and motion using microphone 1200 is shown in FIGS. 19A-D. In FIG. 19A microphone 1200 is in a rest orientation condition 1901 with no light generated from the internal LED ring array 1502. In FIG. 19B, a user has gripped microphone 1200.As a result, LED controller 311 has energized LED ring array 1502. As the user 1903 waves the mic above their head (FIG. 19C) a chosen color pattern appears or when they swing the mic by their side (FIG. 19D), another color pattern might appear in the case of the mic 1200.

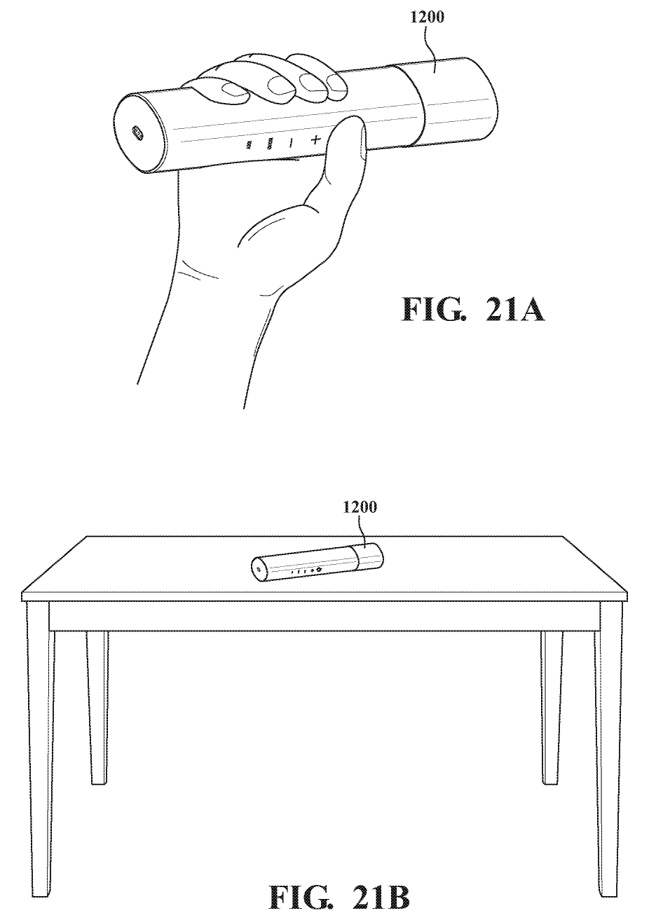

As depicted in FIG. 21A, in certain examples, when a singer grasps the microphone 1200, a touch sensitive circuit (FIG. 4A) detects the touch and activates the mic and/or removes audio mute. In another operational mode (FIG. 21B), when the mic 1200 is placed on a flat surface and the user is no longer holding the mic, the system of the disclosure will detect this state and cause the audio from the mic to be muted understanding that it is no longer in use. In yet another operational mode, if the system of the microphone no longer detects a certain audio level, such as a person speaking or singing directly into the microphone, the microphone audio will automatically be muted after an operator-selectable number of seconds, for example, five seconds. In a further implementation of this automatic muting, in addition to the detection of no audio above a certain level, the microphone detects no (e.g., below a certain threshold) motion by means of the internal motion sensing system described elsewhere in this document.

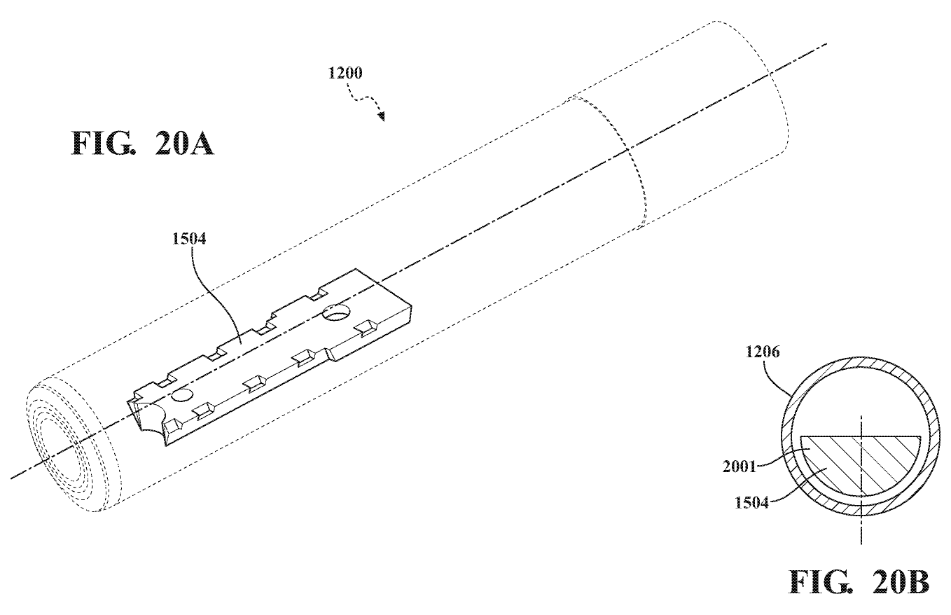

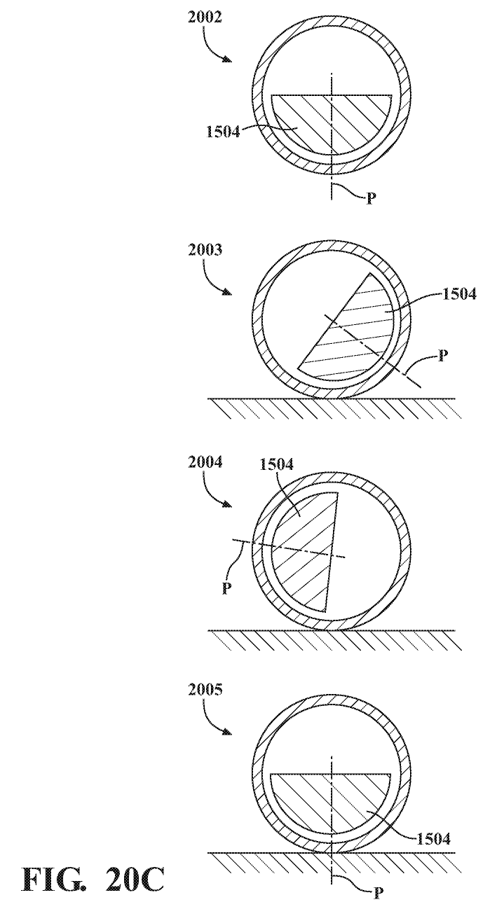

During karaoke performances or other group uses of the karaoke system 100, at the end of a particular performance, the microphone is often simply placed on a flat surface such as table to be picked up and used by singer again after a break in singing or by another performer. In any event, to help prevent the mic from rolling off of a flat surface the mic body contains a built-in weight 1504 (FIGS. 15A, 20A) of lead or another dense material. As seen in FIG. 20A, the weight 504 in one embodiment is semicylindrical with a semicircular cross- sectional profile and of a sufficient length to provide the mass to maintain a predetermined position of the body of the microphone 1200 while resting on a flat surface. In addition to preventing uncontrolled rolling of the mic, this weight 1504 also causes the mic to rest with the control button and digital display of the mic to be facing up from the table providing useful information to a user prior to reaching for the mic for another session. Referring to FIG. 20A anti-rolling weight 1504 is shown in an installed condition in microphone 1200. FIGS. 20B and 20C provide a schematic view of the anti-rolling weight 1504 when viewed along the length axis of the microphone. As indicated in FIGS. 20B and 20C, the center of gravity of the anti-rolling weight lies on the microphone's longitudinal plane of symmetry so that when microphone 1200 is at rest on a flat surface, there is a line P along the outer surface of the weight 1504 which lies in the plane of symmetry and which is where the distance between the anti-rolling weight 1504 and the resting surface is at a minimum. That condition will also define the rotational orientation of the microphone sleeve 1206 relative to the resting surface because the rotational orientation of sleeve 1206 relative to anti-rolling weight 1504 with respect to the length axis L will remain fixed. Relative to initial rest condition 2002, if the microphone 1200 is rotated counter-clockwise to rotational state 2003 and then released, anti-rolling weight 1504 will rotate microphone 1200 clockwise to restore microphone 1200 to the final rest position 2005. Relative to initial rest condition 2002, if microphone 1200 is rotated clockwise to rotational orientation 2004 and then released, anti-rolling weight 1504 will rotate microphone 1200 counter-clockwise to the rest position 2005.

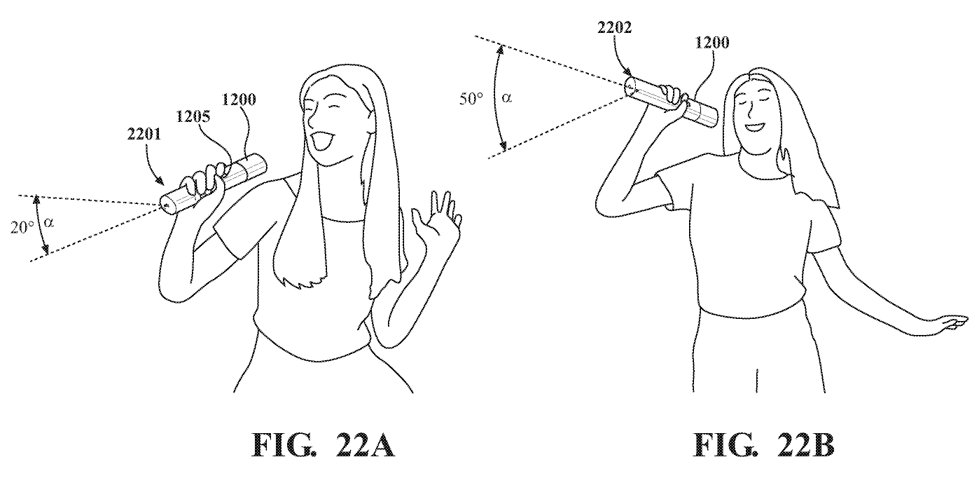

A method of using microphone 1200 to select and modulate a desired vocal effect will now be described with reference to FIGS. 22A and 22B. As depicted in FIGS. 22A, when a singer presses the "Effects Change Button" 1205 (not visible in FIGS. 22A and 22B), a desired audio effect is selected (e.g., chorus, reverb, echo, delay, pitch shift, flange, volume), and the microphone's current orientation 2201 is stored as the reference orientation. As FIG. 22A indicates, the reference orientation will define an initial value of an angle a defined between the length axis L of microphone 1200 and a horizontal plane parallel to the floor or ground. Tilting the microphone up from position 2201 of FIG. 22A to position 2202 of FIG. 22B will in one embodiment increase a value of a parameter defined for the selected vocal effect, for example, increase the depth or intensity of a selected audio effect. Conversely tilting the mic down will decrease the parameter value of the effect. This intuitive control method allows singers to dynamically adjust their sound during performances, enhancing their creative expression.

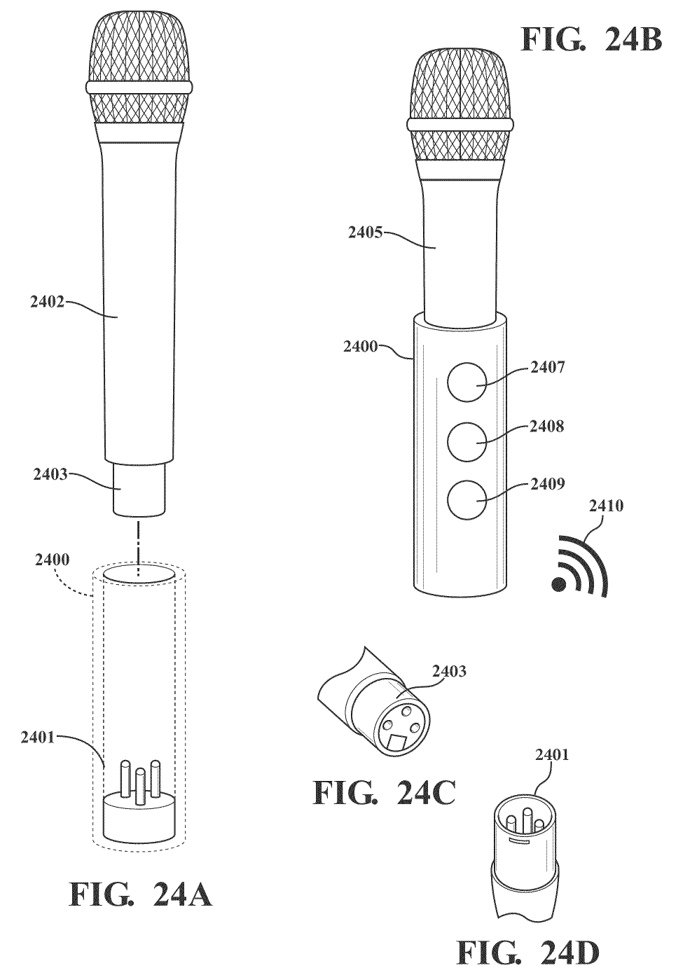

Referring to FIGS. 24A-D and in accordance with another aspect of the present disclosure, a wireless adapter embodied as a smart shell 2400 is provided which allows a wired microphone to be converted to a wireless microphone. FIG. 24A shows a wireless-adapted microphone system in an unassembled configuration. An active mic shell 2400 is provided into which a wired microphone 2402 (i.e., a microphone configured for wired connection to a PA or amplifier) can be inserted. Wired microphone 2402 includes an industry standard female XLR connector 2403 that mates with and electrically connects to a standard, three-pin, male XLR adapter 2401 located in the interior of shell 2400. FIG. 24C is a perspective view of female XLR connector 2403. FIG. 24D is a perspective view of male XLR adapter 2401. Shell 2400 also includes a wireless transmitter 2410 configured to transmit audio and control signals to soundbar 102 using known protocols. Shell 2400 is generally rigid or semi-rigid and includes mechanical or capacitive switches 2407-2409 and corresponding circuitry to carry out corresponding functions. Mechanical or capacitive switch control button 2407 is used to activate microphone 2402, and mechanical or capacitive switch control buttons 2408 and 2409 are used to increase and decrease, respectively, volume or an audio effect parameter value. Where different audio effects are desired, shell 2400 may also include an effects change button to cycle through and select from among different effects (e.g., reverb, echo, flange, chorus, delay, etc.).

In an assembled configuration, a lower-half of microphone 2402 is inserted into shell 2400 such that the male adapter 2401 pins are inserted into the female adapter openings in female XLR adapter 2403. The assembled wireless microphone system of FIG. 24B can then wirelessly connect to the soundbar 102. The shell 2400 can then provide some or all the novel services provides in the microphone 1200 of FIGS. 12A-B.

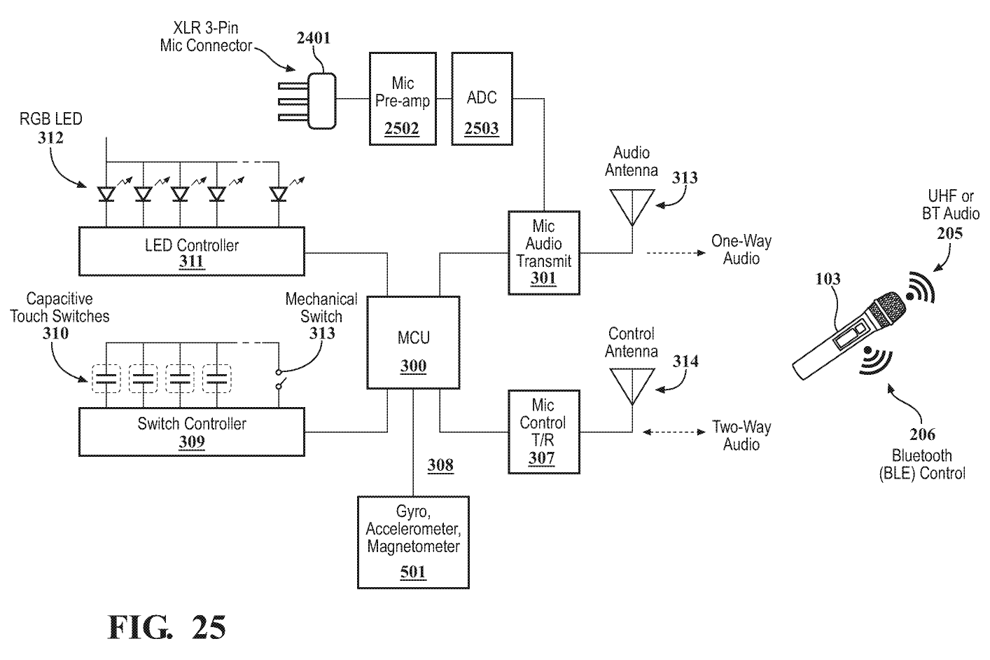

A circuit useful in the shell 2400 of FIGS. 24A and 24B is illustrated in FIG. 25. The diagram in FIG. 25 shows a modification to the circuitry of FIG. 3 where in place of the MEMS microphone element 303 and I2S mic audio processor 302, the circuit anticipates an analog output from the wired microphone 2402 inserted into the smart shell 2400. Thus, the circuit receives the analog signal from the pins of the male XLR connector 2401 and applies a signal amplification means with mic pre-amp 2502 whose output then is applied to an analog-to-digital converted 2503 whose output is I2S to be further processed in the same manner as in FIG. 3.

### Charging Dock

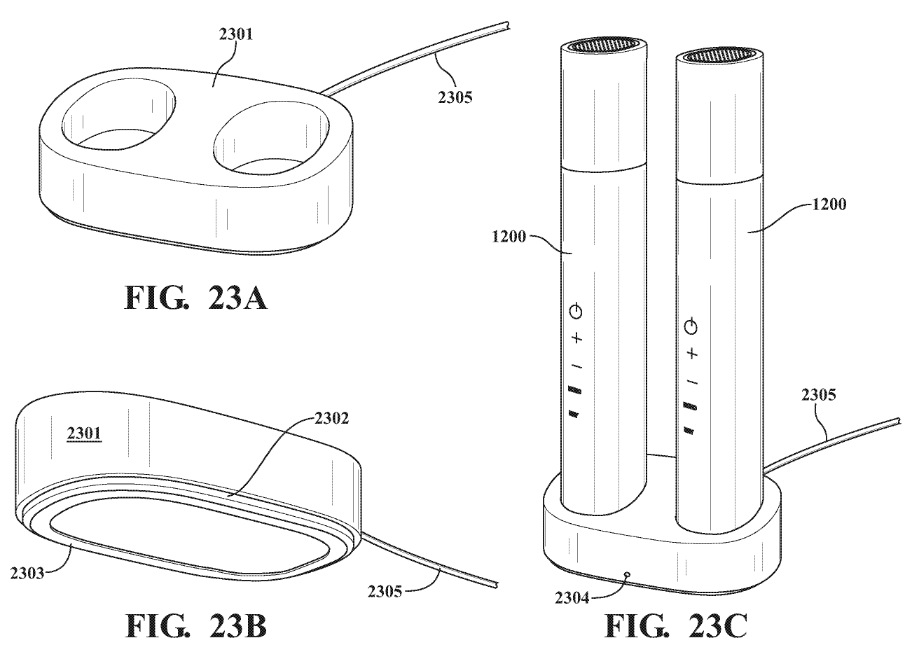

To support the intelligent microphones described herein, a karaoke sound system 100 may be provided which includes a microphone such as microphone 800, 900, or 1200, and a charging dock 2301, as illustrated in FIGS. 23A-C. Charging dock 2301 may be provided with and connectable to a detachable power cable 2305 using USB-C connectivity. The dock 2301 has a power indication RGB LED 2304, providing visual feedback on the charging status of the microphone 1200. This assembly charges the microphones to be ready for use.

### Additional Attachments to the Microphone Controller Base

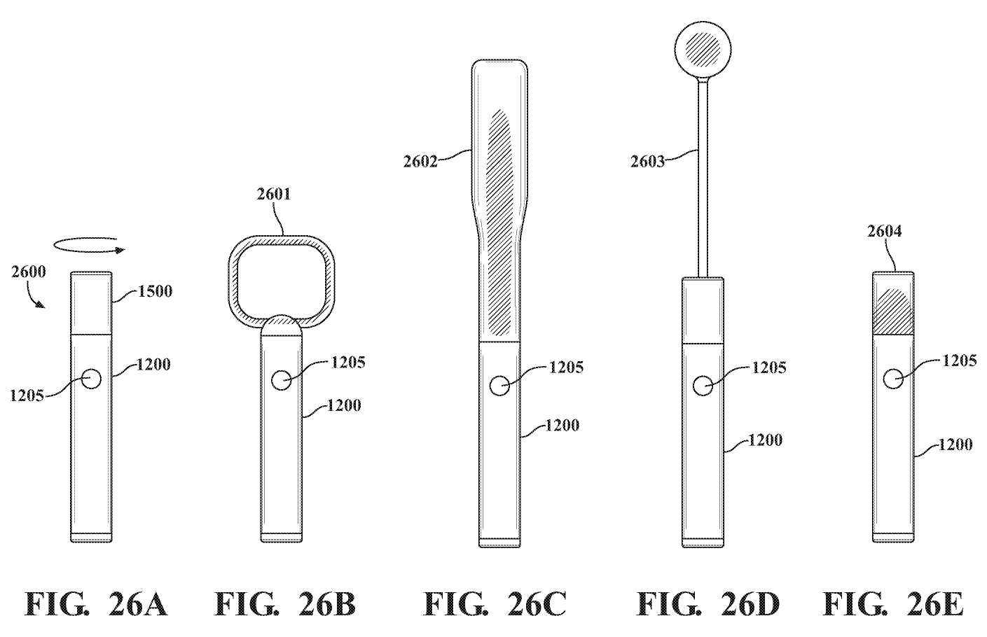

Referring now to FIGS. 26A-E, in certain examples, karaoke microphones 900 and 1200 can be converted to game controllers by removing the microphone capsule (or "cage") such as capsule 1510 of FIG. 15A (or the combination of fabric grille 901 and an attached acoustic transducer that is not visible in FIG. 9A) and installing an attachment specific to a particular video game. The game controller then wirelessly communicates with a base station (not shown) that transmits video, audio, and images to a connected display. In these examples, the attachment includes a wholly or partially translucent housing, a light source, such as an LED array, and leverages the microphone circuitry (FIG. 3), in particular MCU 300 and inertia sensor 501 as well as the capacitive switches in control regions 903, 1204 (not shown in FIGS. 26A-E). In preferred examples, MCU 300 is loaded with programs tailored to the various available attachments, such as programs for generating control signals transmitted from control transceiver 307 to a base station (FIG. 3) and programs for activating and deactivating light sources such as LED arrays within the gaming attachment based on inertial sensor signal 308 and/or control signals received from the base station. The attachments may also include their own LED controllers that respond to commands from MCU 300.

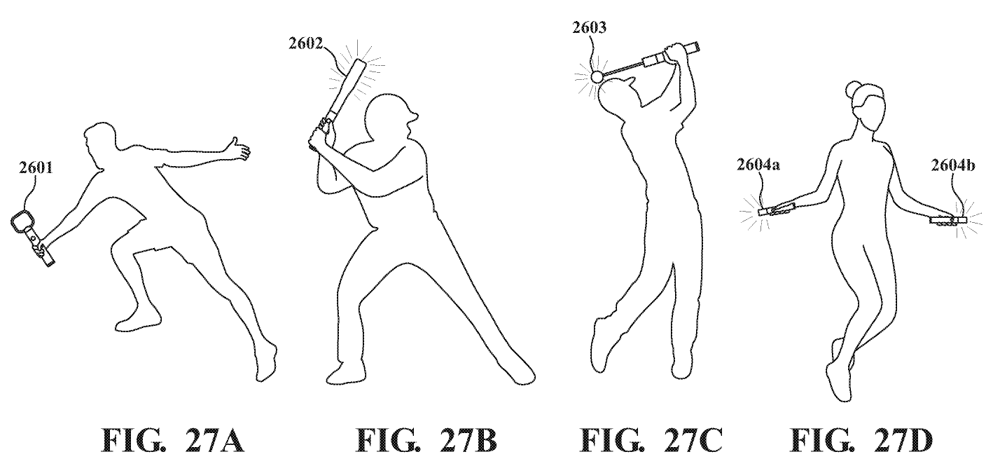

Referring to FIG. 26A, karaoke microphone 1200 is shown and comprises a removable microphone capsule 1510 described previously. Capsule 1510 is replaced with one of gaming attachments 2601 (tennis racket/ping pong paddle), 2602 (baseball bat), 2603 (golf club), and 2604 (jump rope). Each attachment is formed from a wholly or partially translucent plastic and includes one or more internal RGB LED arrays in optical communication with the translucent plastic. In preferred examples, the LEDs are activated and deactivated in correspondence to the movement of the attachment based on inertial sensor signal 308 (FIG. 3) or control signals received from the base station and/or control signals transmitted from the base station back to the controller via control antenna 314 and control transceiver 307 (FIG. 3). For example, when a program executed by MCU 300 determines that the motion of the racket/paddle attachment 2601 (as indicated by inertia sensor 501) will cause the racket/paddle attachment 2601 to (virtually) collide with a tennis or ping pong ball shown on a video display based on the ball's calculated trajectory, the LEDs may be briefly illuminated. FIGS. 27A-D illustrate the illumination of each attachment in use and show positions of persons using the sports wands for various sporting types.

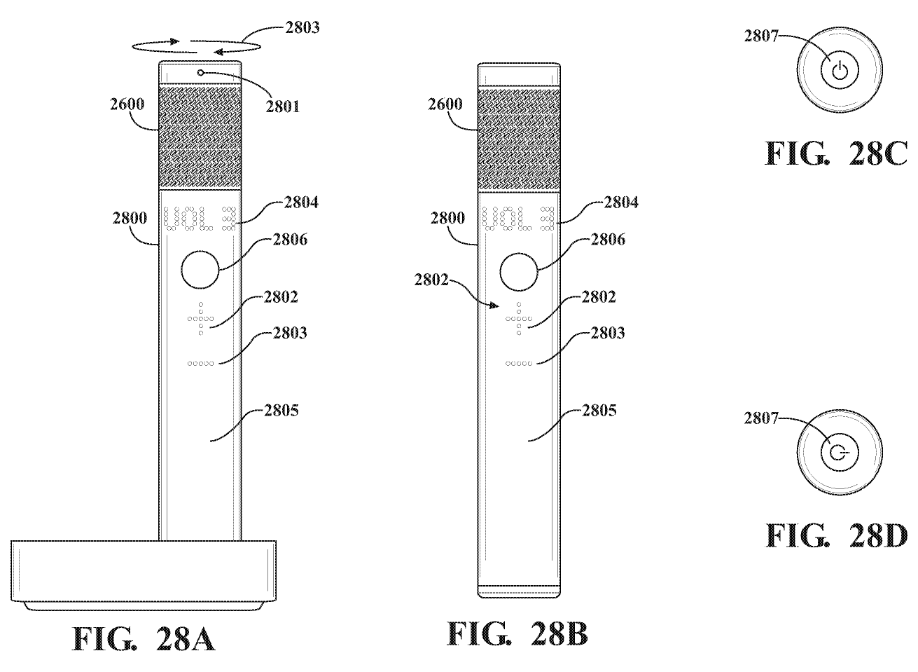

In accordance with another aspect of the present disclosure, microphones are provided which can be user configured for close up or far field microphone voice pickup. In the example of FIGS. 28A-D, microphone 2800 is provided. Microphone 2800 comprises a translucent housing 2805 in optical communication with one more internal RGB LEDs which may be illuminated in the manner previously described and for the purposes previously described with respect to microphones 900 and 1200.

Volume control regions 2802 and 2803 are regions on housing 2805 where capacitive switches may be actuated to effect volume increase and volume decrease operations, respectively. Printed "+" and "-" graphics underneath translucent housing 2805 are visible through housing 2805 when the corresponding capacitive switch and LEDs are activated as described previously with respect to microphones 900 and 1200. Power button 2810 is provided on the top of microphone 2800 and is depressible to provide power to the microphone.

LED power indicator 2801 is provided to indicate when microphone is connected to charging dock 2301. Effects change control button 2806 is provided and operates like effects change control button 909 (FIG. 9B). The user can twist the microphone capsule head 2808 about the lengthwise central axis L microphone 2800 to switch between near-field and far-field use. FIGS. 28A shows microphone 2800 sitting in charging dock 2301 in a charging mode in which the charging contacts of the microphone 2800 are in electrical communication with the charging contacts of the dock 2301. FIG. 28C shows the top of microphone 2800 when viewed downward along the lengthwise axis L in a direction from above microphone 2800. In FIGS. 28A and 28C, capsule head 2808 is in a first rotational position about the lengthwise axis L that configures microphone 2800 for far field use so that microphone 2800 can be used at a distance by a user, i.e., due to the electrical connection of the charging portion of microphone 2800 with the charging portion of dock 2301, the internal circuitry in microphone 2800 remains energized despite the microphone not being held by a user. As a result, charging indicator 2801 is illuminated.

In FIGS. 28B and 28D, capsule head 2808 has been rotated 90 degrees counterclockwise (when viewed from above) relative to FIGS. 28A and 28C, and microphone 2800 is in near field mode. As a result, the microphone only transmits audio and control signals when being held by a user as detected by one or more capacitive switches that detect the presence of the user's hand. In some examples, microphone 2800 is selectively energized by an internal power source based on the detection of the user holding microphone 2800. In certain examples, when switching to close up (near-field) use (FIGS. 28B and 28D), a high-pass (low- cut) filter in the microphone's circuitry is applied to attenuate low-frequency signals, mitigating the proximity effect during close-miking. When the intended use is far-field (FIGS. 28A and 28C), the opposite is chosen, which is to switch off the high-pass filter. In another embodiment, the microphone's 2800 polar pattern can be altered such that a user can switch to a cardioid pattern for close-up singing (which is almost by definition, most of the time.) When far-field microphone use is desired, the user can switch to an omnidirectional pickup pattern.

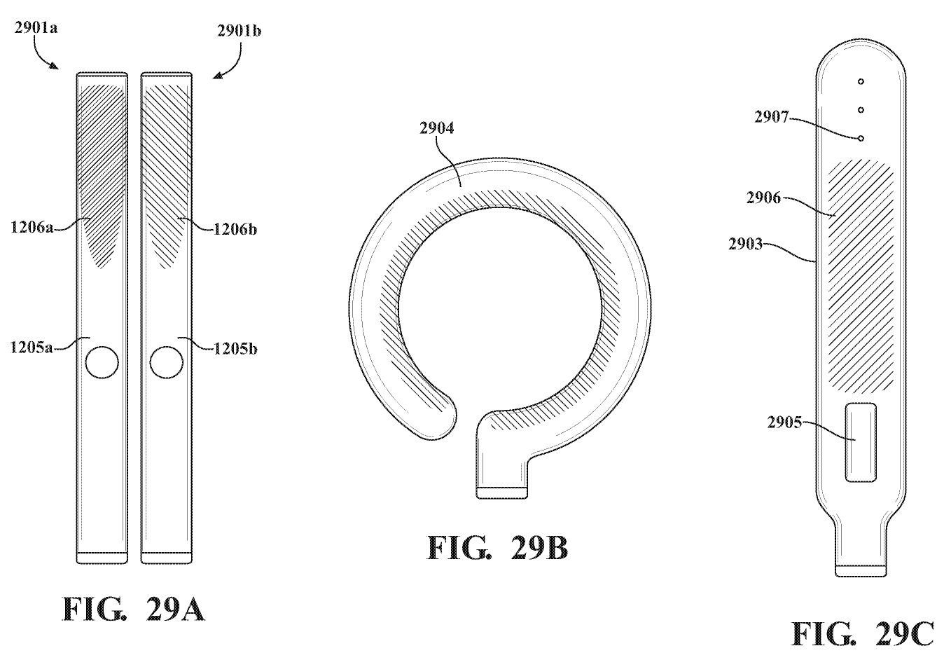

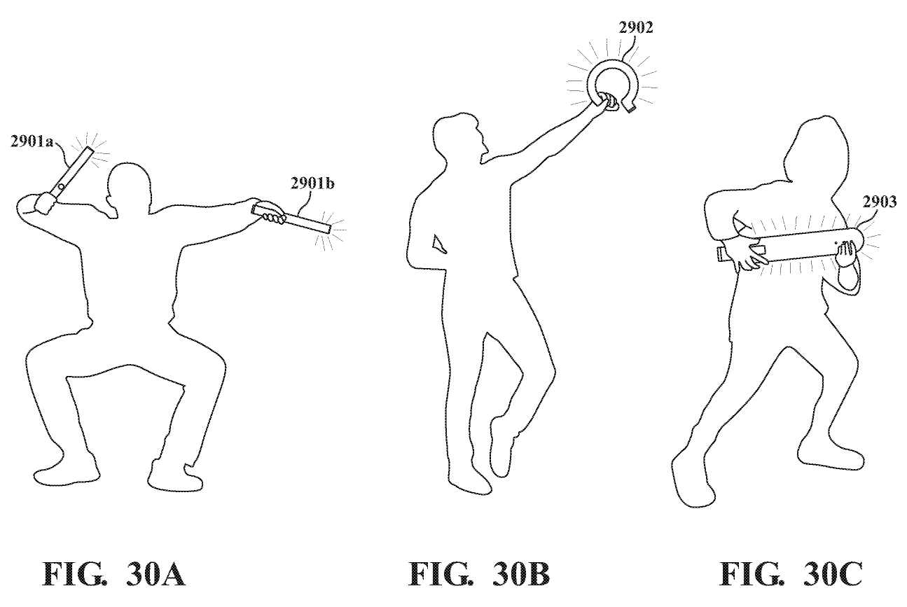

In accordance with another aspect of the present disclosure (FIGS. 29A-29C and 30A-3031), hand held controllers with internal light sources and translucent housings are provided wherein the controllers emulate musical instruments. Referring to FIG. 29A, two drumstick hand held controllers 2901a and 2901b are depicted. In one example, the drumsticks 2901a, 2901b are configured by removing microphone capsule or cage 1510 from microphone 1200 and replacing it with an upper cylindrical attachment portion 2902a and 2902b that includes its own internal RGB LED array and LED controller. Each drumstick 2901a and 2901b includes circuitry similar to FIG. 3. Each respective MCU 300 includes program storage with programs tailored to activating and deactivating the RGB LEDs within the upper cylindrical attachment portion 2902a, 2902b in synchronization with the movement of the drumsticks 2901a, 2901b and/or music being played (e.g., by a base station) while the user drums in the air (FIG. 30A) with the drumsticks. The drumsticks 2901a and 2901b transmit control signals to a base station via a respective transceiver 307 and a respective antenna 314 (FIG. 3). The base station generates drum sounds in response to the movement of the drumstick 2901a and 2901b as indicated by inertial sensor signal 308 and corresponding control signals sent to the base station via transceiver 307 and control antenna 314. The drumsticks may use capacitive switches on the microphone body for selecting and modulating different audio effects (e.g., reverb, chorus, echo, delay, pitch shift, and flange) to be applied to a tambourine sound generated by the base station.

Tambourine 2904 (FIG. 29B) controller comprises a circular, tubular translucent housing with one or more internal RGB LED arrays, an internal LED controller, an inertial sensor, a transceiver and antenna for two-way communication with a base station, and an internal system on a chip (SoC) with a processor and storage for programs used to generate LED lighting sequences and control signals. Tambourine 2904 may be a stand-alone item, not an attachment for a portion of microphone 1200. Programs stored on the system on a chip preferably direct the LED controller to illuminate the internal LEDs in synchronization with the movement of the tambourine 2904 and/or music played by the base station (as indicated by the inertial sensor and/or control signals transmitted from the base station to tambourine 2904). Tambourine 2904 may also be configured with one or more capacitive switches for selecting and modulating different audio effects (e.g., reverb, chorus, echo, delay, and flange) to be applied to a tambourine sound generated by the base station.

Guitar 2903 controller (FIG. 29C) comprises an elongated, translucent housing with one or more internal RGB LED arrays, an internal LED controller, an inertial sensor, a transceiver and antenna for two-way communication with a base station, an internal system on a chip (SoC) with a processor and storage for programs used to generate LED lighting sequences and control signals. Programs stored on the system on a chip preferably direct the LED controller to illuminate the internal LEDs in synchronization with the movement of the tambourine 2904 and/or music played by the base station (as indicated by the inertial sensor and/or control signals transmitted from the base station to guitar 2903). Guitar 2903 may also be configured with one or more capacitive switches for selecting and modulating different audio effects (e.g., reverb, chorus, echo, delay, pitch shift, and flange) to be applied to a tambourine sound generated by the base station. FIGS. 30A-30C show users interacting with the instruments of FIGS. 29A-C and the illumination of the microphone and instruments that results.

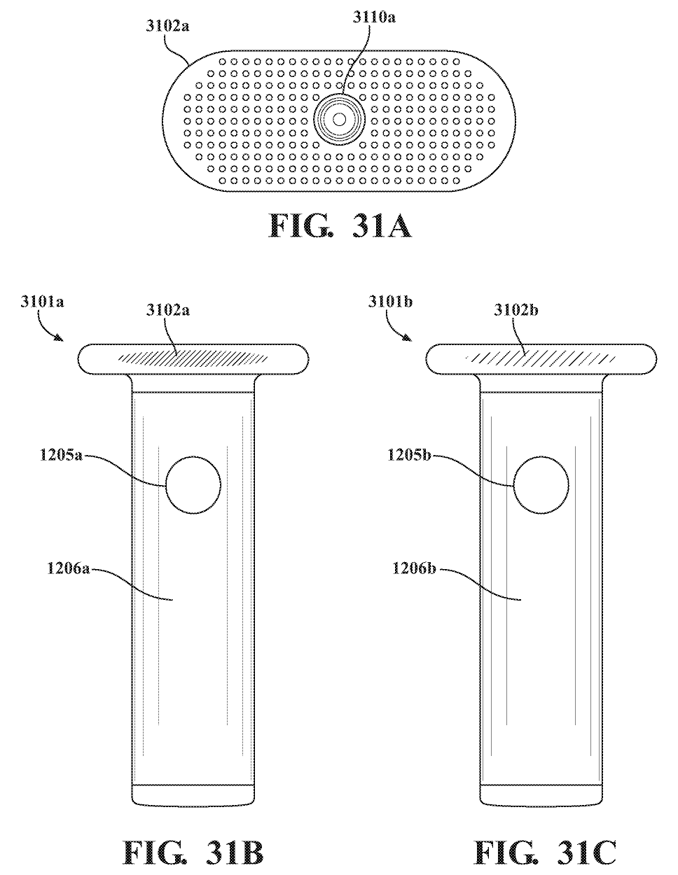

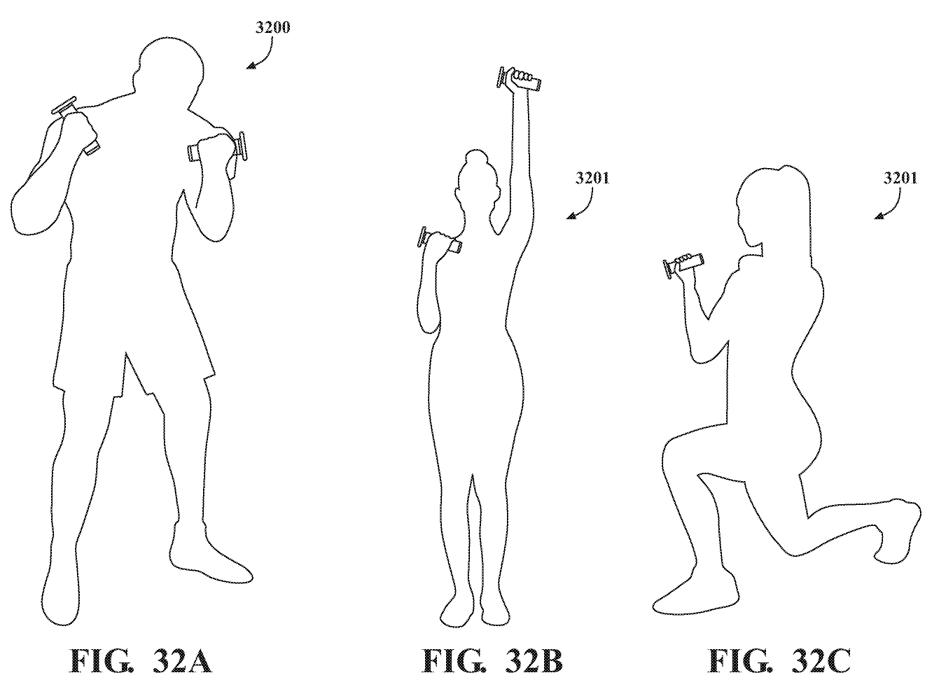

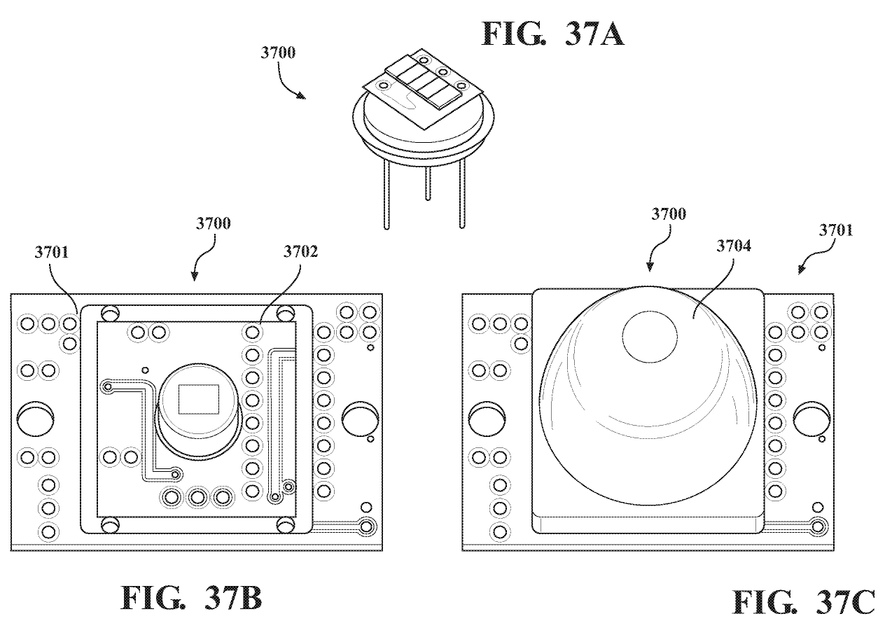

In accordance with another aspect of the present disclosure, handheld gaming controllers are provided which include a passive infrared (PIR) sensor/camera sensor for motion detection. The PIR/camera sensor is provided in an illuminated housing and is attachable to a portion of microphone 1200 by detaching microphone cage/capsule 1510. Referring to FIGS. 31B and 31C, two handheld controllers 3101a and 3101b are provided which comprise a lower portion of respective microphones 1200 with a camera housing 3102a, 3102b provided in place of the microphone capsule 1510. FIG. 31A shows the camera housing 3102a and passive IR sensor/camera 3110a associated controller 3101a. FIG. 31B shows camera housing 3102b and passive IR sensor/camera 3110b associated with controller 3101b. As indicated in FIGS. 31B and C, each camera housing 3102a and 3102b is wholly or partially translucent and includes internal arrays of RGB LEDs and an associated LED controller. Each controller 3101a, 3101b also includes a transparent sleeve 1206a, 1206b and effects change control button 1205a, 1205b, as described previously with respect to FIGS. 12A-12B. Programs stored in the MCU 300 for each controller 3101a and 3101b drive the LED controllers to light their respective LEDs based on inertial sensor signals 308 (FIG. 3) for each of the controllers 3101a, 3101b as well as control signals received by each of the controllers 3101a and 3101b via their respective control antennas 314 and transceivers 307. The controllers may be used in a number of ways, including for boxing 3200 (FIG. 32A) and as dumbbells 3201 (FIGS. 32B and 32C). FIGS. 37A-B illustrate a passive infrared device 3700 suitable for use as passive IR sensor/cameras 3110a and 3110b. showing the integrated circuit opened and exposing the sensor elements. FIG. 37A shows printed circuit board 3701 and sensor element 3702 mounted on the PCB 3701 with diffusion lens 3704 removed. FIG. 37B shows printed circuit board 3701 with and 3702 shows diffusion lens mounted over the sensor element 3702.

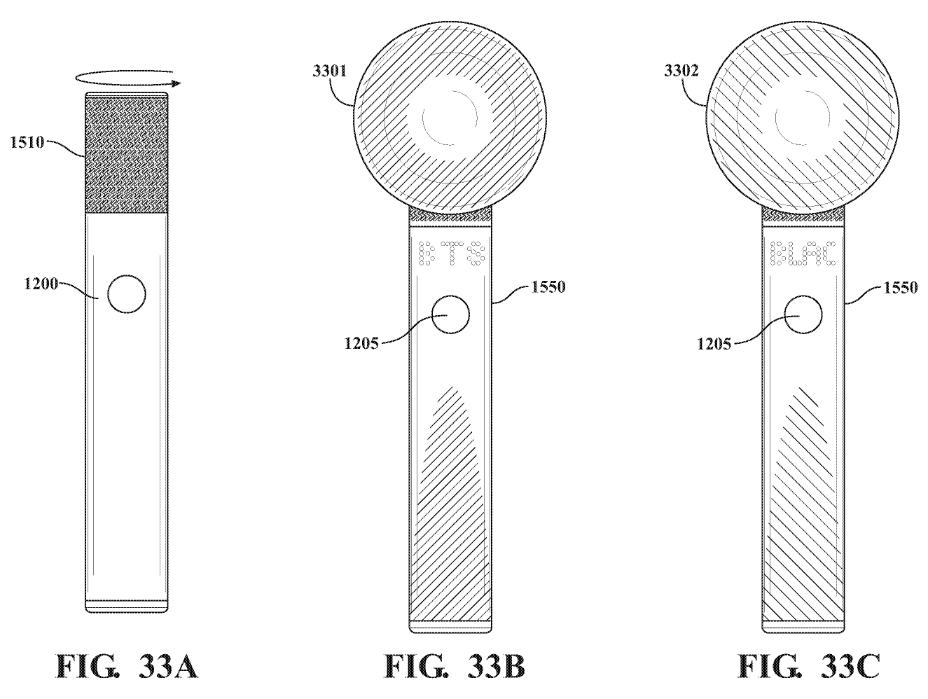

In accordance with another aspect of the present disclosure, a cheering stick 1550 is provided (FIGS. 33B-33C) by replacing microphone capsule 1510 of microphone 1200 with a glowing sphere. Referring to FIG. 33A, karaoke microphone 1200 is shown. In FIGS. 33B and 33C, microphone capsule 1510 of FIG. 15A has been replaced with respective glow spheres 3301 and 3302. The glowing spheres 3301 and 3302 may be formed from translucent plastic, include one or more RGB LED arrays and an associated LED controller. Programs resident in the MCU 300 (FIG. 3) direct the LED controllers in the spheres 3301 and 3302 to illuminate the LEDs in the spheres based on signals from their respective inertial sensors 501.

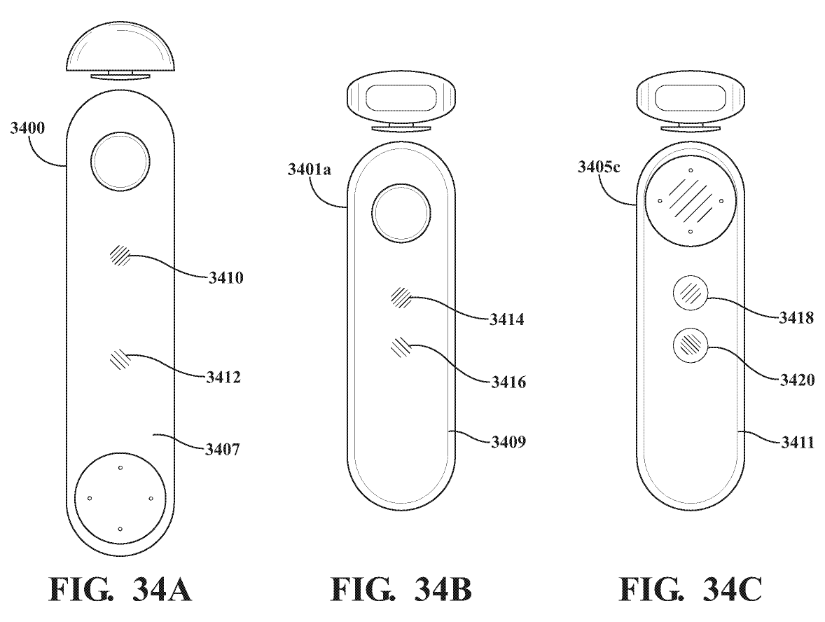

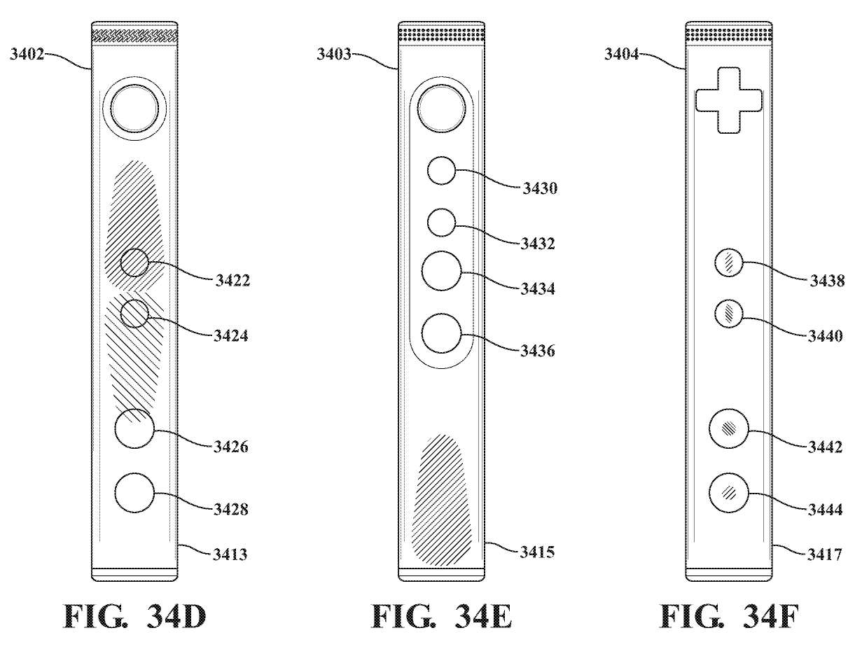

The devices in FIGS. 34A-F are game controllers 3400-3405 for playing video games projected on a smart TV. Each includes game controller 3500-3405 a respective translucent housing 3407, 3409, 3411,3413, 3415, 3417, one or more RGB LED arrays, a system on a chip, a transceiver an antenna, and an inertial sensor. Programs resident on the system on a chip may illuminate the RGB LEDs based on signals provided by the inertial sensor and/or information provided by a base station via the transceiver. As the figures indicate, different LEDs may be localized to different respective areas of each controller. Thus, game controller 3400 has LED areas 3410 and 3412, game controller 3401 has LED areas 3414 and 3416, and game controller 3405 has LED areas 3418 and 3420. Game controller 3402 has LED areas 3422, 3424, 3426, and 3428, game controller 3403 has LED areas 3430, 3432, 3434, and 3436, and game controller 3404 has LED areas 3438, 3440, 3442, and 3444. Each LED area is an area of the respective housing 3407, 3409, and 3411 where light from the internal LED array may selectively appear.

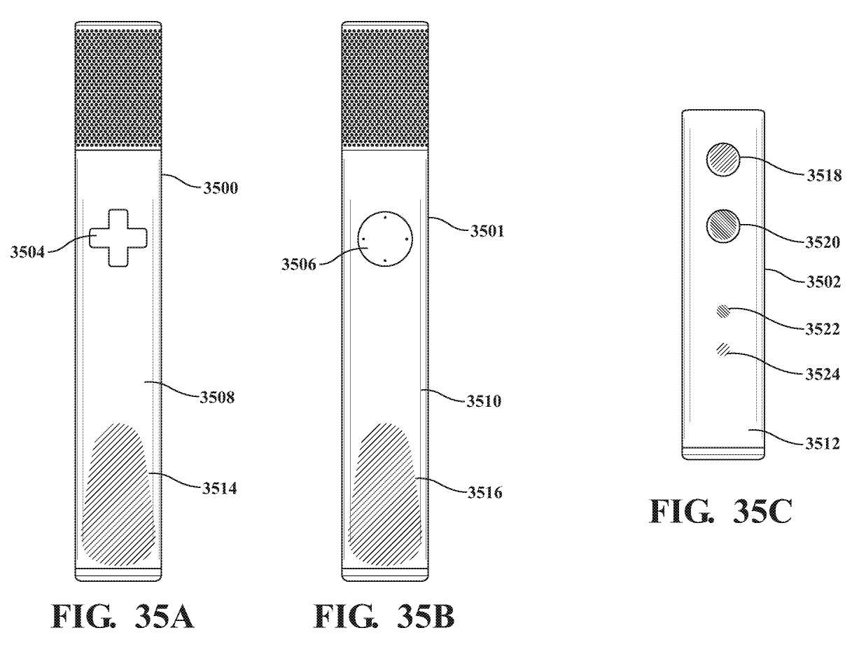

FIGS. 35A and 35B show two variants of left-hand gaming controller 3500 and 3501, each of which is use with a right hand controller 3502 shown in FIG. 35C. The controllers 3500 and 3501 have respective translucent housings 3508 and 3510. The controllers 3500 and 3501 of FIGS. 35A and 35B are essentially modified versions of karaoke microphone 1200 of FIGS. 2A-B. In FIG. 35A the effects change control button 1205 has been replaced with a directional, cross-shaped, DPAD 3504. In FIG. 35B the effects change control button 1205 has been replaced with a circular DPAD 3506. The respective MCUs 300 of each of the controllers of FIGS. 35A and 35B are preferably programmed to activate the respective LED arrays 1502 (FIG. 15B) based on their respective inertial sensor signals 308 and based on the activation of their respective DPADs 3504, 3506 and/or based on control signals received from their respective base stations by their respective control antennas 314 and transceivers 307.

Translucent housing 3508 of controller 3500 has LED area 3514. Translucent housing 3510 of controller 3501 has LED area 3516. The LED areas are translucent areas in optical communication with selectively activatable LEDs.

FIG. 35C depicts a right hand gaming controller 3502 for use with one of the left hand controllers 3500 and 3501 of FIGS. 35A and 35B. The controller 3502 is not a modified version of karaoke microphone 1200. It includes a translucent housing 3512 that houses one or more RGB LED arrays, a system on a chip, a transceiver, an antenna, and an inertial sensor. It may also include one or more capacitive switches configured to illuminate one of the RGB LED arrays and/or transmit control signals to a base station via the transceiver and antenna. The capacitive switches selectively illuminate a respective one of the housing's LED areas 3518, 3520, 3522, and 3524.

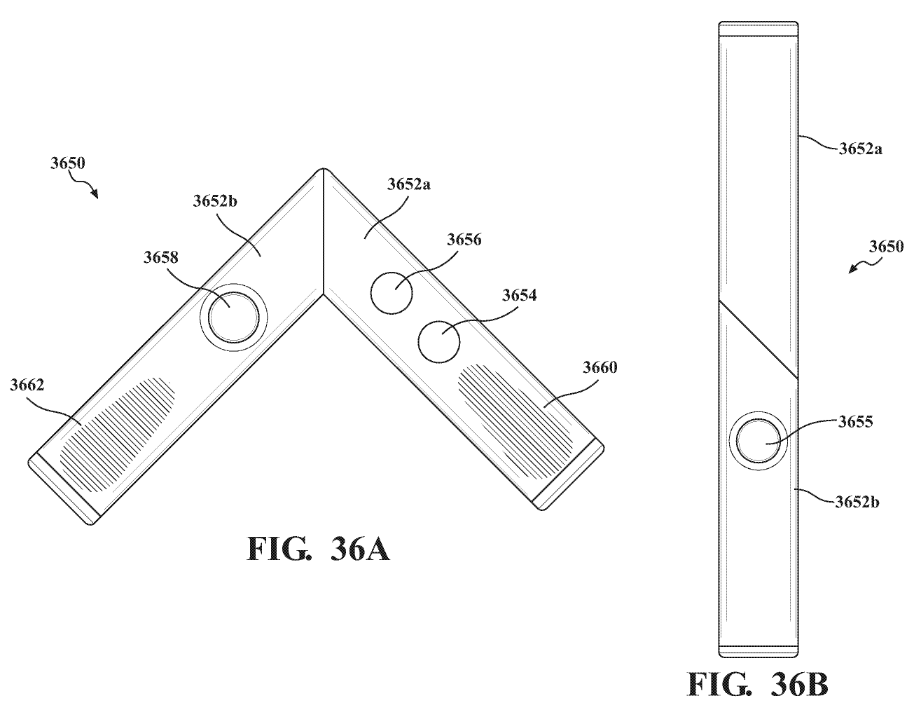

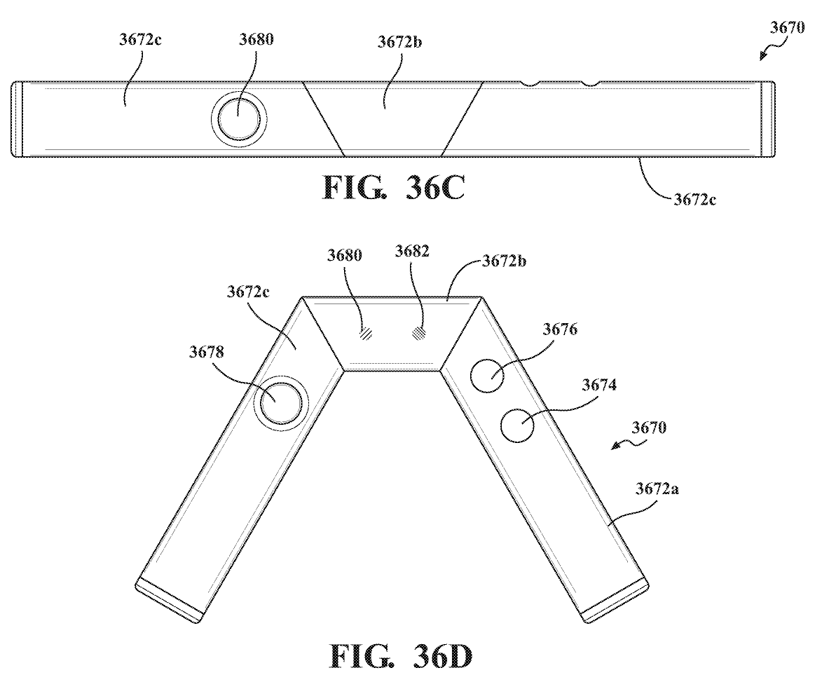

FIGS. 36A and 36B depict a foldable gaming controller 3650 in both a folded (FIG. 36A) and unfolded (FIG. 36B) configuration. The controller housing comprises two housing sections 3652a and 3652b which are wholly or partially translucent, plastic, and foldable into a right-angle (half-rectangular) shape. Gaming controller 3650 and includes a plurality of control buttons 3654, 3655, 3656, and 3658, each of which may be push buttons and/or capacitive switch buttons. Two RGB LED arrays are provided at opposite ends of the controller to transmit light through the translucent housing LED areas 3660 and 3662 which are located at two opposite ends of controller 3650 as shown in FIG. 36A. FIGS. 36C and 36D depict gaming controller 3670. Controller 3652 comprises translucent plastic housing sections 3672a, 3672b, and 3672c. The end housing sections 3672a and 3672c are foldable relative to middle housing section 3672b to define a half-hexagonal shape instead of a half-rectangular case, as in FIGS. 36A and 36B. Control buttons 3674, 3676, 3678, and 3680 are provided. LED areas 3680 and 3682 are areas of the translucent housing section 3672b which are in optical communication with selectively activatable LEDs in internal LED arrays located within middle housing section 3672b.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

1. A microphone, comprising:
an inertial sensor;
a control unit operatively connected to the inertial sensor; and
a transmitter, wherein the control unit is operatively connected to the transmitter and causes the transmitter to transmit a control signal.

2. The microphone of claim 1, wherein in response to a selected inertial sensor signal, the control unit is adapted to cause the transmitter to transmit the control signal.

3. The microphone of claim 1, wherein the corresponding control signal is a vocal effect modulation signal.

4. The microphone of , further comprising an effects change control, wherein actuation of the effects change control adjusts a vocal effect signal that corresponds to the selected inertial sensor signal.

5. The microphone of claim 1, wherein the microphone further comprises a housing and a translucent sleeve disposed about the housing.

6. The microphone of claim 5, further comprising a capacitive sensor operatively connected to the control unit.

7. The microphone of claim 6, further comprising at least one light source in optical communication with the translucent sleeve and operatively connected to the control unit, wherein the control unit is configured to energize the at least one light source based on a capacitive sensor signal generated by the capacitive sensor and an inertial sensor signal generated by the inertial sensor.

8. The microphone of claim 1, further comprising at least one capacitive sensor operatively connected to the control unit, wherein in response to a capacitive sensor signal generated by the at least one capacitive sensor, the control unit causes the transmitter to transmit a corresponding control signal.

9. The microphone of claim 8, wherein the corresponding control signal is a volume control signal, a volume effects actuation signal, or a musical key adjustment signal.

10. The microphone of claim 1, further comprising a semi-cylindrical weight having a length parallel to a length axis of the microphone.

11. The microphone of claim 1, wherein the transmitter transmits the control signal to a soundbar comprising at least one speaker, at least one wireless signal receiver, a processor, and a vocal effects module, and
wherein the control signal causes the vocal effects module to apply a vocal effect to an audio signal received from the microphone.

12. A microphone, comprising:
at least one light source;
a translucent sleeve in optical communication with the at least one light source such that when the at least one light source is energized, light generated by the at least one light source is visible from an outer surface of the translucent sleeve; and
at least one of a capacitive sensor and an inertial sensor operatively connected to the at least one light source, wherein the at least one light source is energized in response to a sensor signal generated by the at least one of a capacitive sensor and an inertial sensor.

13. The microphone of claim 12, wherein the at least one of a capacitive sensor and an inertial sensor is a capacitive sensor and an inertial sensor, and the light source is energized in response to sensor signals generated by each of the capacitive sensor and the inertial sensor.

14. The microphone of claim 12, wherein the capacitive sensor signal is generated in response to a human hand gripping the translucent sleeve, and the inertial sensor signal is generated in response to a movement of the microphone.

15. The microphone of claim 12, further comprising a semi-cylindrical weight having a length parallel to a length axis of the microphone.

16. The microphone of claim 12, wherein a color emitted by the at least one light source is controlled by an application of a mobile device.

17. A method of using a microphone that includes at least one light source, comprising:
gripping the microphone; and
altering an orientation of the microphone relative to the Earth, whereby the light source emits light.

18. The method of claim 17, further comprising:
actuating an effects change control to select a vocal effect to be applied to an audio signal;
varying the orientation of the microphone relative to the earth to thereby vary a vocal effect parameter corresponding to the vocal effect.

19. The method of claim 18, wherein the microphone comprises a capacitive sensor operatively connected to a light source controller, and the step of gripping the microphone causes the capacitive sensor to generate a capacitive sensor signal.

20. The method of claim 19, wherein the microphone has a length defining a length axis and when the light source controller energizes the at least one light source, light is transmitted a distance along the length axis of the microphone, and the distance varies with a singing volume.
